(19) United States
(12) Patent Application Publication
(10) Pub. No.: US 2025/0365260 A1
(43) Pub. Date: Nov. 27, 2025

(54) NETWORK CALL METHOD AND APPARATUS, DEVICE, AND MEDIUM

(71) Applicant: Tencent Technology (Shenzhen) Company Limited, Shenzhen (CN)

(72) Inventors: Tieming HUANG, Shenzhen (CN); Bin LI, Shenzhen (CN); Li LIN, Shenzhen (CN); Jinhui GUO, Shenzhen (CN); Yanghua LI, Shenzhen (CN); Qiang HUANG, Shenzhen (CN)

(21) Appl. No.: 19/290,216

(22) Filed: Aug. 4, 2025

Related U.S. Application Data
(63) Continuation of application No. PCT/CN2024/094178, filed on May 20, 2024.

(30) Foreign Application Priority Data
Jul. 25, 2023 (CN) 202310923187.1

(51) Int. Cl. H04L 51/10; H04L 51/043; H04M 7/00

(52) U.S. Cl. CPC H04L 51/10; H04L 51/043; H04M 7/006

(57) ABSTRACT

This application relates to a network voice call method performed by a computer device. The method includes: in response to a call trigger operation triggered by a first communication user in a first instant messaging application, creating a virtual room configured for a network voice call and adding the first communication user to the virtual room; transmitting a child application card indicating the virtual room to a second instant messaging application used by a second communication user; the second instant messaging application and the first instant messaging application being different types of applications; and enabling the first and second communication users to participate in the network voice call in the virtual room by using a network call engine integrated in the first and second instant messaging applications, respectively.

### CROSS-REFERENCE TO RELATED APPLICATIONS

This application is a continuation application of PCT Patent Application No. PCT/CN2024/094178, entitled “NETWORK CALL METHOD AND APPARATUS, DEVICE, AND MEDIUM” filed on May 20, 2024, which claims priority to Chinese Patent Application No. 2023109231871, entitled “NETWORK CALL METHOD AND APPARATUS, DEVICE, AND MEDIUM” filed with the China National Intellectual Property Administration on Jul. 25, 2023, both of which are incorporated herein by reference in their entirety.

### FIELD OF THE TECHNOLOGY

This application relates to network call technologies, and in particular, to a network call method and apparatus, a device, and a medium.

### BACKGROUND OF THE DISCLOSURE

With development of an instant messaging technology, a network call technology based on an instant messaging application appears. A network call, also referred to as a voice call or Voice over Internet Protocol (VOIP), refers to a technology of performing voice communication by using the Internet as a transmission medium. In conventional telephone communication, a voice signal is transmitted by using a telephone line, in a network call, a voice signal is converted into a digital signal by using a data transmission capability of the Internet, and the digital signal is transmitted by using a data network. This means that the network call may be a call by using any device (such as a computer, a mobile phone, or a tablet) connected to the Internet. A conventional telephone line and telephone operator are no longer relied on, but data transmission is performed by using a network. A network call provides a voice communication service by using the Internet and performs transmission by using a digital signal. The convenience and advanced functions of the network call make the network call one of important manners of modern communication.

In a conventional technology, a network call path is relatively single, and participants of the network call usually need to install and use the same instant messaging application for implementation. This has limitations, resulting in low network call efficiency.

### SUMMARY

This application provides a network call method and apparatus, a device, and a medium.

According to a first aspect, this application provides a network voice call method performed by a computer device, the method including:
in response to a call trigger operation triggered by a first communication user in a first instant messaging application, creating a virtual room configured for a network voice call and adding the first communication user to the virtual room;
transmitting a child application card indicating the virtual room to a second instant messaging application used by a second communication user; the second instant messaging application and the first instant messaging application being different types of applications; and
enabling the first and second communication users to participate in the network voice call in the virtual room by using a network call engine integrated in the first and second instant messaging applications, respectively.

According to a fifth aspect, this application provides a computer device, including a memory and a processor, where the memory stores a computer program, and the processor implements operations in the method embodiments of this application when executing the computer program.

According to a sixth aspect, this application provides a non-transitory computer-readable storage medium, having a computer program stored therein, and operations in the method embodiments of this application are implemented when the computer program is executed by a processor of a computer device.

According to a seventh aspect, this application provides a computer program product, including a computer program, and operations in the method embodiments of this application are implemented when the computer program is executed by a processor.

Details of one or more embodiments of this application are provided in the accompanying drawings and descriptions below. Other features, objectives, and advantages of this application become apparent from the specification, the drawings, and the claims.

### BRIEF DESCRIPTION OF THE DRAWINGS

To describe technical solutions in embodiments of this application or the conventional technology more clearly, the following briefly introduces the accompanying drawings required for describing the embodiments or the conventional technology. Apparently, the accompanying drawings in the following description show only embodiments of this application, and a person of ordinary skill in the art may still derive other drawings from the accompanying drawings without creative efforts.

FIG. 1 is an application environment diagram of a network call method according to an embodiment.

FIG. 2 is a schematic flowchart of a network call method according to an embodiment.

FIG. 3 is a schematic diagram of an exemplary manner of a call entry according to an embodiment.

FIG. 4 is a schematic diagram of a page for waiting for an invited object to join a call according to an embodiment.

FIG. 5 is a schematic diagram of joining a call by a second instant communication user, and performing a related operation on a call interface according to an embodiment.

FIG. 6 is a schematic diagram of a page of a second instant communication user when a quantity of video objects exceeds a preset quantity according to an embodiment.

FIG. 7 is a schematic diagram of a page for creating and receiving a call in a first instant messaging application according to an embodiment.

FIG. 8 is a schematic diagram of a page for inviting an outside-group communication user to join a call according to an embodiment.

FIG. 9 is a schematic diagram of changes of a member region and a control region in a call interface, when a quantity of call objects exceeds a particular relevant preset quantity according to an embodiment.

FIG. 10 is a schematic diagram of an effect of zooming in a profile photo and turning a page in a first instant messaging application according to an embodiment.

FIG. 11 is a schematic diagram of a process and an effect of a presentation screen in a first instant messaging application according to an embodiment.

FIG. 12 is a schematic diagram of a process and an effect of watching a presentation screen in a first instant messaging application according to an embodiment.

FIG. 13 is a schematic diagram of a process and an effect of watching a presentation screen in a second instant messaging application according to an embodiment.

FIG. 14 is a schematic diagram of an interface on which a first communication user manages a call member in a first instant messaging application according to an embodiment.

FIG. 15 is a schematic diagram of an interface on which a first communication user manages a call member in a first instant messaging application according to another embodiment.

FIG. 16 is a schematic diagram of an interface presented by a member in a first instant messaging application when a first communication user is invited to enter a call according to an embodiment.

FIG. 17 is a schematic diagram of a process in which a first communication user mutes all call members according to an embodiment.

FIG. 18 is a schematic diagram of a page about a mute prompt in a first instant messaging application when a first communication user is invited to enter a call and is muted according to an embodiment.

FIG. 19 is a schematic diagram of a related page for processing a mute release application by a first communication user according to an embodiment.

FIG. 20 is a schematic diagram of a page on which a first communication user unmutes all members and performs more management on a call according to an embodiment.

FIG. 21 is a schematic diagram of a page of a member mute reminder received by a second communication user according to an embodiment.

FIG. 22 is a schematic diagram of a page of all mute reminders received by a second communication user according to an embodiment.

FIG. 23 is a schematic diagram of a page of network instability and call hang-up according to an embodiment.

FIG. 24 is a schematic diagram of a cross-platform architecture of a first communication application according to an embodiment.

FIG. 25 is a schematic flowchart of managing a call member according to an embodiment.

FIG. 26 is a schematic diagram of member state flow according to an embodiment.

FIG. 27 is a schematic flowchart of a network call method according to another embodiment.

FIG. 28 is a sequence diagram showing that a second communication user enters a virtual room according to an embodiment.

FIG. 29 is a schematic diagram of a cross-platform architecture of a second communication application according to an embodiment.

FIG. 30 is a schematic flowchart of a network call method according to still another embodiment.

FIG. 31 is a structural block diagram of a network call apparatus according to an embodiment.

FIG. 32 is a structural block diagram of a network call apparatus according to another embodiment.

FIG. 33 is an internal structural diagram of a computer device according to an embodiment.

### DESCRIPTION OF EMBODIMENTS

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

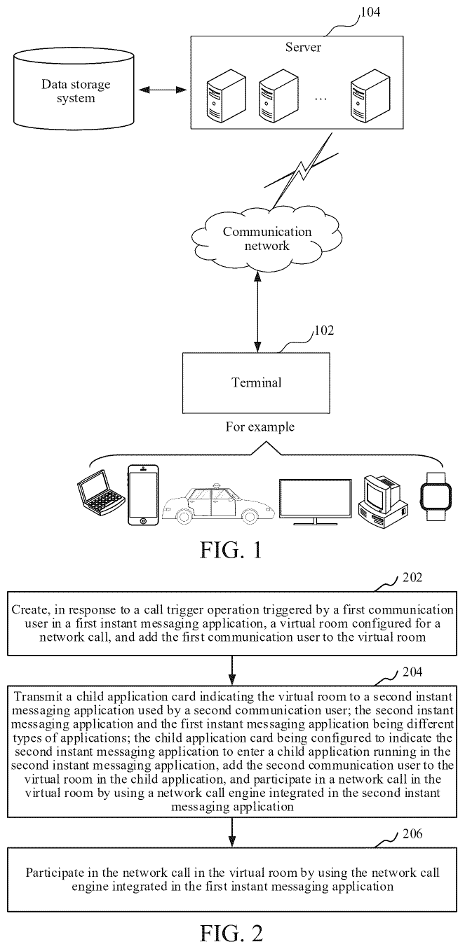

A network call method provided in this application may be applied to an application environment shown in FIG. 1. A terminal 102 communicates with a server 104 by using a network. A data storage system may be separately disposed and may store data that needs to be processed by the server 104. The data storage system may be integrated on the server 104, or may be placed on cloud or another server. The terminal 102 may be but is not limited to various desktop computers, laptops, smartphones, tablet computers, Internet of Things devices, and portable wearable devices. The Internet of Things device may be an intelligent sound box, an intelligent television, an intelligent air conditioner, an intelligent in-vehicle device, or the like. The portable wearable device may be a smart watch, a smart band, a head-mounted device, or the like. The server 104 may be an independent physical server, a server cluster or a distributed system including a plurality of physical servers, or may be a cloud server providing basic cloud computing services such as a cloud service, a cloud database, cloud computing, cloud functions, cloud storage, a network service, cloud communication, a middleware service, a domain name service, cloud security, network security services such as host security, a content delivery network (CDN), big data, artificial intelligence platforms, and the like. The terminal 102 and the server 104 may be directly or indirectly connected in a wired or wireless communication protocol. This is not limited in this application.

The terminal 102 may create a virtual room configured for a network call in response to a call trigger operation triggered by a first communication user in a first instant messaging application, add the first communication user to the virtual room, and transmit a child application card indicating the virtual room to a second instant messaging application used by a second communication user. The second instant messaging application and the first instant messaging application are different types of applications; and the child application card is configured to indicate the second instant messaging application to enter a child application running in the second instant messaging application, add the second communication user to the virtual room in the child application, and participate in a network call in the virtual room by using a network call engine integrated in the second instant messaging application. The terminal 102 may participate in the network call in the virtual room by using the network call engine integrated in the first instant messaging application.

The virtual room includes a logical room maintained on a first communication platform, and further includes a multimedia room maintained on a second communication platform. The first communication platform and the second communication platform may be deployed on the same server 104, or may be deployed on different servers 104. The first communication platform is configured to support remote interaction with the first instant messaging application running on the terminal, and the second communication platform is configured to support remote interaction with the second instant messaging application running on the terminal. The logical room is configured to support interaction logic of the virtual room, and the multimedia room is configured to support multimedia interaction of the virtual room. This is not limited in this embodiment. The application scenario in FIG. 1 is merely illustrative and is not limiting.

In an embodiment, as shown in FIG. 2, a network call method is provided. The method may be applied to a first terminal running a first instant messaging application to which a first communication user logs in, and includes the following operations:

Operation 202: Create, in response to a call trigger operation triggered by a first communication user in a first instant messaging application, a virtual room configured for a network call, and add the first communication user to the virtual room.

The first communication user is a communication user logging in to the first instant messaging application. The instant messaging application is an application program configured to support instant messaging, and the instant messaging application is a client application. The virtual room is a virtual room configured for supporting a network call. The network call may include at least one of a network voice call or a network video call implemented based on the Internet.

Specifically, the first instant messaging application may be run on the first terminal, and the first communication user may log in to the first instant messaging application. The first communication user may trigger a network call in the first instant messaging application, so that the first terminal may create, in response to a call trigger operation triggered by the first communication user in the first instant messaging application, a virtual room configured for a network call, and add the first communication user to the virtual room. After creating the virtual room in response to the call trigger operation, the first terminal automatically adds the first communication user initiating the network call to the created virtual room.

In an embodiment, the first communication user may trigger a two-person network call for the second communication user in the first instant messaging application, that is, the first communication user invites the second communication user to perform a two-person network call. Further, the first terminal may create a virtual room configured for a network call, and add the first communication user to the virtual room in response to a call trigger operation that is triggered by the first communication user in the first instant messaging application and that is for two persons. The second instant communication user may also enter the virtual room, and the first communication user and the second communication user may perform a network call in the virtual room. The second communication user is a communication user logging in to the second instant messaging application, and the second instant messaging application and the first instant messaging application are different types of applications. The second instant messaging application and the first instant messaging application are two different types of applications configured for supporting instant messaging.

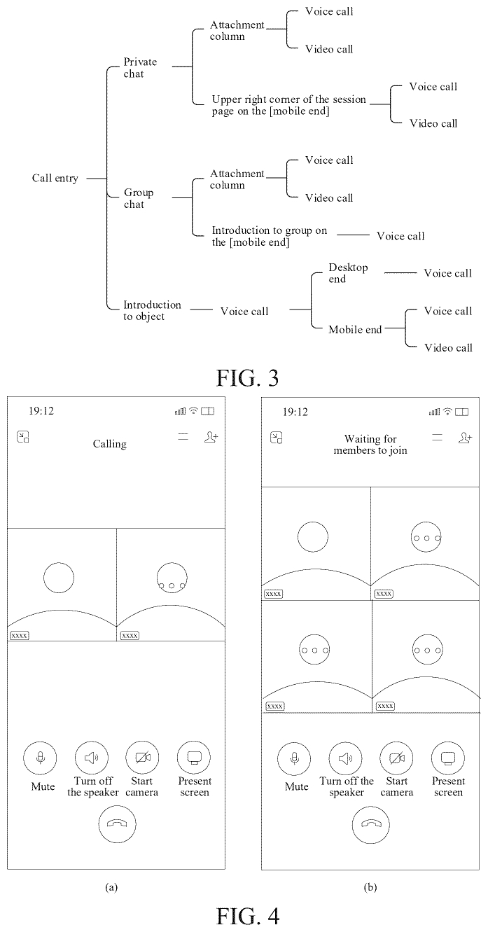

In an embodiment, as shown in FIG. 3, the first instant messaging application includes a first instant messaging application on a mobile end and a first instant messaging application on a desktop end. The network call includes a network voice call and a network video call. The first communication user may trigger a network call for a group or two persons in the first instant messaging application. For a two-person network call, the first communication user may trigger the network call on a private session page of a chat with the second communication user. For the first instant messaging applications on the mobile end and the desktop end, a voice call or a video call may be initiated from an attachment bar of a private chat session page. For the first instant messaging application on the mobile end, a voice call or a video call may also be initiated by triggering a call control at the upper right corner of the private chat session page. In addition, for a two-person network call, the first communication user may further trigger the network call on an object profile page for the second communication user. A voice call may be initiated for the first instant messaging application on the desktop end. A voice call or a video call may be initiated for the first instant messaging application on the mobile end. For a network call for a group, the first communication user may trigger the network call on a group session page including the first communication user and the second communication user. For the first instant messaging applications on the mobile end and the desktop end, a voice call or a video call may be initiated from an attachment bar of a group session page. A voice call may alternatively be initiated in a group introduction page for the group for the first instant messaging application on the mobile end.

In an embodiment, referring to part (a) in FIG. 4, for a two-person network call, after the first communication user initiates a network call invitation to the second communication user, the first terminal may display identification images of the first communication user and the second communication user on a call interface, and before the second communication user enters the call, an animation for representing that the second communication user is joining may be dynamically displayed above the identification image of the second communication user, and prompt information of “calling” may be displayed on the call interface. For a network call for a group, after the first communication user initiates a network call invitation to each communication user in the group, the first terminal may display the first communication user and an identification image of each communication user in the group on a call interface, and before each communication user in the group enters the call, an animation for representing that each communication user in the group is joining may be dynamically displayed above the identification image of each communication user in the group, and prompt information of “waiting for members to join” may be displayed on the call interface.

Operation 204: Transmit a child application card indicating the virtual room to a second instant messaging application used by a second communication user. The second instant messaging application and the first instant messaging application are different types of applications; and the child application card is configured to indicate the second instant messaging application to enter a child application running in the second instant messaging application, add the second communication user to the virtual room in the child application, and participate in a network call in the virtual room by using a network call engine integrated in the second instant messaging application.

The child application card is a container that is in the child application and that is configured for carrying information content, and can be triggered to enter a child application. The child application card may be configured for carrying information indicating a virtual room. The child application may be an online application, and running of the child application needs to rely on the Internet. The child application is an application program that runs in a running environment provided by a parent application, and a target application program runs on an operating system. Both the first instant messaging application and the second instant messaging application may be parent applications. The child application, the first instant messaging application, and the second instant messaging application are all different types of applications. The first instant messaging application and the second instant messaging application are both client applications. The network call engine is an independently encapsulated software module supporting a network call function, and may be configured to support a communication protocol configured for a network call.

Specifically, after the virtual room to which the first communication user is added has been created, the first terminal may transmit the child application card indicating the virtual room to the second terminal running the second instant messaging application to which the second communication user logs in. Further, the second terminal may receive the child application card, and display the child application card in the second instant messaging application to which the second communication user logs in. The second terminal may run, in response to a trigger operation performed by the second communication user on the child application card, a child application indicated by the child application card in the second instant messaging application. The second terminal may add the second communication user to the virtual room by using the child application, and participate in the network call in the virtual room by using the network call engine integrated in the second instant messaging application.

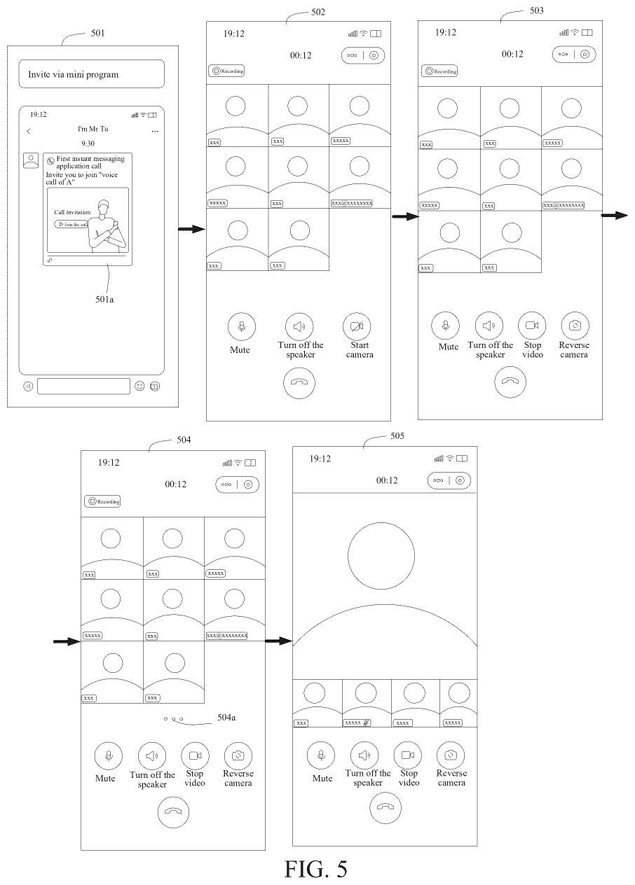

In an embodiment, the child application includes a mini program application, and the child application card includes a mini program card. As shown in FIG. 5, after the first terminal transmits a mini program card indicating the virtual room to the second instant messaging application used by the second communication user, the second terminal running the second instant messaging application may receive and display a mini program card 501a on a session page 501 with the first communication user. The second terminal may enter a mini program application in response to a trigger operation on the mini program card, add the second communication user to a virtual room in which a multi-person call exists in the mini program application, and display a multi-person call interface 502. The second terminal may enter a network video call interface 503 in response to a trigger operation on an “open camera” control in the call interface 502. When a quantity of objects joining the network call is greater than a preset display quantity, a network video call interface 504 is displayed, and a page turning control 504a is displayed in the network video call interface 504. In response to a trigger operation for an identification image of a communication user, another network video call interface 505 may be displayed, and the triggered identification image of the communication user is zoomed in on the network video call interface 505.

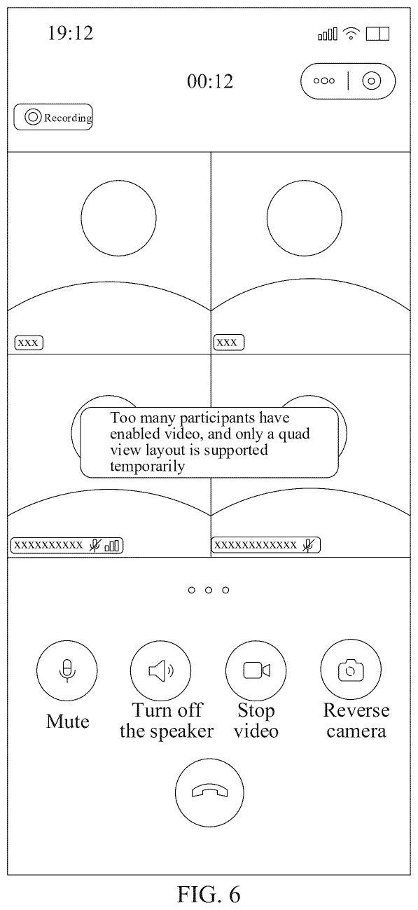

In an embodiment, as shown in FIG. 6, after the first terminal transmits the mini program card indicating the virtual room to the second instant messaging application used by the second communication user, the second terminal running the second communication application may receive and enter, in response to a trigger operation on the mini program card, the mini program application running on the second communication application, add, in the mini program application, the second communication user to the virtual room in which a multi-person call exists, and display a multi-person call interface. During a network call, if a quantity of communication users enabling video is greater than a preset video channel quantity, prompt information indicating that an upper limit of the video channel quantity is reached, for example, “too many participants have enabled video, and only a quad view layout is supported temporarily”, is displayed in the call interface.

Operation 206: Participate in the network call in the virtual room by using the network call engine integrated in the first instant messaging application.

The network call engine integrated in the first instant messaging application and the network call engine integrated in the second instant messaging application can communicate by using an agreed communication protocol, to support a network call function.

Specifically, after the second communication user joins the virtual room, the first terminal may participate in the network call in the virtual room by using the network call engine integrated in the first instant messaging application. The first communication user and the second communication user may perform a cross-application network call in the same virtual room.

In the foregoing network call method, a virtual room configured for a network call is created in response to a call trigger operation triggered by the first communication user in the first instant messaging application, the first communication user is added to the virtual room, and a child application card indicating the virtual room is transmitted to the second instant messaging application used by the second communication user. The second instant messaging application and the first instant messaging application are different types of applications; and the child application card is configured to indicate the second instant messaging application to enter a child application running in the second instant messaging application, add the second communication user to the virtual room in the child application, and participate in a network call in the virtual room by using a network call engine integrated in the second instant messaging application. The network call is participated in the virtual room by using the network call engine integrated in the first instant messaging application. Compared with a conventional call manner in which all call participants can implement a network call only when based on the same instant messaging application, the limitation in the conventional technology that the same instant messaging application needs to be configured for performing network communication is broken through.

In this application, the same network call engine is integrated into instant messaging applications of different types, based on the same network call engine, and instant communication users logging in by using different instant messaging applications are added to the same virtual room by using a child application, so that instant communication users logging in by using different instant messaging applications can perform a cross-application network call in the virtual room, thereby improving network call efficiency, and in particular, improving network call efficiency for a multi-person network call scenario.

In an embodiment, the network call method further includes: recording call voice content of the network call in the virtual room, and converting the call voice content into call text content; and transmitting the call text content to the second instant messaging application used by the second communication user. In this embodiment, the call voice content recorded in the network call process is converted into the call text content, and the call text content is transmitted to the second instant messaging application, so that the call content can be reproduced while network resources are saved, thereby further improving network call efficiency.

In an embodiment, the network call method further includes: recording call voice content of the network call in the virtual room, and converting the call voice content into call text content; and transmitting the call voice content and the call text content to the second instant messaging application used by the second communication user. In this embodiment, the call voice content recorded in the network call process is converted into the call text content, and the call voice content and the call text content are transmitted together to the second instant messaging application, so that the call content can be reproduced in more diversified forms, thereby further improving network call efficiency.

In an embodiment, the network call method further includes: recording call voice content of the network call in the virtual room, and converting the call voice content into call text content; performing topic extraction on the call text content, to obtain at least one topic text; generating, based on the call text content, a reply text respectively corresponding to each topic text; and transmitting the topic text and the reply text to the second instant messaging application used by the second communication user. In this embodiment, call voice content recorded in a network call process is converted into call text content, a general topic text is extracted from the call text content, and a corresponding reply text is generated, so that call content can be briefly reproduced while network resources are saved, thereby further improving network call efficiency.

In an embodiment, the creating, in response to a call trigger operation triggered by a first communication user in a first instant messaging application, a virtual room configured for a network call, and adding the first communication user to the virtual room includes: creating, in response to a call trigger operation triggered by the first communication user on an interworking group existing in the first instant messaging application, a virtual room configured for a network call, and adding the first communication user to the virtual room, the interworking group including the first communication user and the second communication user.

In an embodiment, the first instant messaging application includes a group session page set for the interworking group. The first terminal may create a virtual room configured for a network call in response to a call trigger operation triggered by the first communication user on a group session page of the first instant messaging application, and add the first communication user to the virtual room.

In an embodiment, an interworking group including the first communication user and the second communication user exists in the first instant messaging application. The first terminal may create, in response to a call trigger operation triggered by the first communication user on the interworking group existing in the first instant messaging application, a virtual room configured for a network call, and add the first communication user to the virtual room; and the second communication user may be added to the virtual room, and participate in a network call in the virtual room.

In an embodiment, in addition to the first communication user and at least one second communication user, the interworking group may further include a third communication user logging in to a third instant messaging application. The third instant messaging application is the same type of application as the first instant messaging application. The first terminal may create, in response to a call trigger operation triggered by the first communication user on the interworking group existing in the first instant messaging application, a virtual room configured for a network call, and add the first communication user to the virtual room; the second communication user and the third communication user may be added to the virtual room, and participate in the network call in the virtual room.

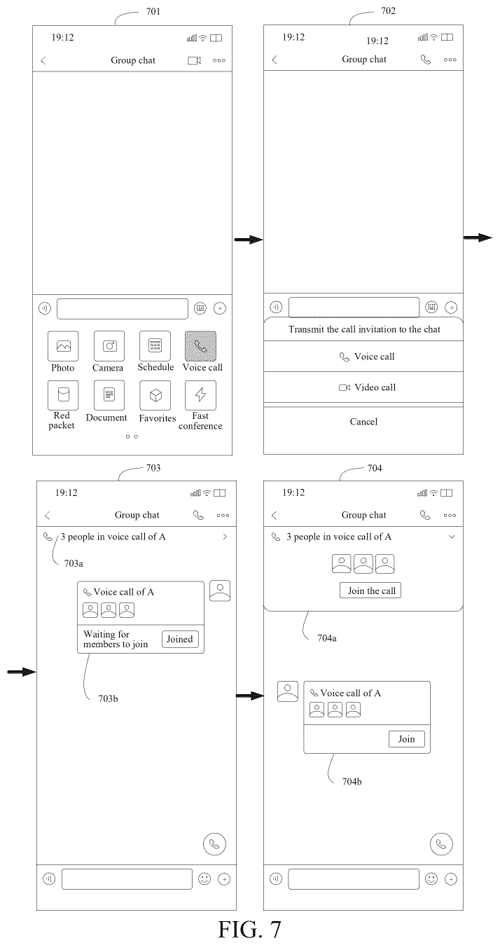

In an embodiment, as shown in FIG. 7, a group session page 701 of an interworking group includes a “voice call” control. In response to a trigger operation performed by the first communication user on the “voice call” control on the group session page 701, a control configured to trigger a voice call or a video call is displayed on the group session page 702. In response to the trigger operation of the first communication user on the “voice call” control, the first terminal may create a virtual room configured for a network call, add the first communication user to the virtual room, and display, on the group session page 703, a call card 703b configured for representing that the room has been created.

In the foregoing embodiment, by triggering the call trigger operation in the interworking group, the communication users in the interworking group may be invited to join the same virtual room at the same time, and a cross-application network call is performed in the same virtual room, thereby improving efficiency of a multi-person network call.

In an embodiment, the interworking group further includes a third communication user logging in to a third instant messaging application. The third instant messaging application is the same type of application as the first instant messaging application. The method further includes: displaying, on a group session page of the interworking group when the first communication user is inside the created virtual room, call invitation information transmitted by the third instant messaging application; the call invitation information designating a virtual room which is designated by the third communication user and includes the third communication user; and adding, in response to a trigger operation performed by the first communication user on the call invitation information displayed on the group session page, the first communication user to the virtual room designated by the third communication user, and participating in a network call in the virtual room designated by the third communication user. In this embodiment, the first communication user in the interworking group not only can initiate a network call, but also can join the virtual room designated by the third communication user in the interworking group while joining the virtual room created by the first communication user, thereby further improving efficiency of a multi-person network call.

In an embodiment, the adding, in response to a trigger operation performed by the first communication user on the call invitation information displayed on the group session page, the first communication user to the virtual room designated by the third communication user, and participating in a network call in the virtual room designated by the third communication user includes: suspending the network call of the first communication user in the created virtual room in response to a trigger operation of the first communication user on the call invitation information displayed on the group session page; where when the network call is suspended, the first communication user still remains in the created virtual room; and adding the first communication user to the virtual room designated by the third communication user, and participating in a network call in the virtual room designated by the third communication user. In this embodiment, when the first communication user is triggered to join the virtual room designated by the third communication user, the network call of the first communication user in the virtual room created by the first communication user is suspended, so as to limit that the first communication user can participate in a network call only in one virtual room at the same time, thereby avoiding mutual interference between a plurality of virtual rooms at the same time, and further improving efficiency of a multi-person network call.

In an embodiment, the network call method further includes: enabling a network call of the first communication user in the created virtual room in response to a call enabling operation for a network call of the virtual room created by the first communication user, and suspending the network call of the first communication user in the virtual room designated by the third communication user; where when the network call is suspended, the first communication user still remains in the virtual room designated by the third communication user. In this embodiment, network calls of a plurality of virtual rooms are switched between suspended and enabled, so as to limit that the first communication user can participate in a network call only in one virtual room at the same time, thereby avoiding mutual interference between a plurality of virtual rooms at the same time, and further improving efficiency of a multi-person network call.

In an embodiment, the network call method further includes: combining, in response to a room combination operation for the virtual room created by the first communication user and the virtual room designated by the third communication user, the virtual room created by the first communication user with the virtual room designated by the third communication user; and adding communication users in the virtual room created by the first communication user and communication users in the virtual room designated by the third communication user to a combined virtual room, and participating in a network call in the combined virtual room. In this embodiment, the virtual room created by the first communication user and the virtual room designated by the third communication user are combined into one virtual room, and the communication users in the virtual room created by the first communication user and the communication users in the virtual room designated by the third communication user are supported to participate in a network call in the same virtual room, thereby further improving efficiency of a multi-person network call.

In an embodiment, the interworking group further includes a third communication user logging in to a third instant messaging application. The third instant messaging application is the same type of application as the first instant messaging application. The method further includes: displaying, on a group session page of the interworking group when the first communication user is outside the created virtual room, call invitation information transmitted by the third instant messaging application; the call invitation information designating a virtual room which is designated by the third communication user and includes the third communication user; and adding, in response to a trigger operation performed by the first communication user on the call invitation information displayed on the group session page, the first communication user to the virtual room designated by the third communication user, and participating in a network call in the virtual room designated by the third communication user.

The situation in which the first communication user is outside the created virtual room may be understood as a situation in which the first communication user exists before creating the virtual room, or a situation in which the first communication user exits the virtual room created by the first communication user. The call invitation information is information configured for inviting a communication user to enter a network room to participate in a network call.

In an embodiment, when the first communication user is outside the created virtual room, the first terminal may display, on the group session page of the interworking group, the call invitation information transmitted by the third instant messaging application. The call invitation information designates a virtual room created or shared by the third communication user and including the third communication user. The first communication user may perform a trigger operation on the call invitation information displayed on the group session page. Further, the first terminal may add, in response to a trigger operation performed by the first communication user on the call invitation information displayed on the group session page, the first communication user to the virtual room designated by the third communication user, and participate in the network call in the virtual room designated by the third communication user.

In the foregoing embodiment, the first communication user in the interworking group not only can initiate a network call, but also can participate in a network call initiated or shared by the third communication user in the interworking group, thereby further improving efficiency of a multi-person network call.

In an embodiment, the displaying, on a group session page of the interworking group, call invitation information transmitted by the third instant messaging application includes: displaying a call invitation prompt in a notification region in a collapsed state of the group session page; the call invitation prompt pointing to the call invitation information transmitted by the third instant messaging application; expanding the notification region in the collapsed state into a notification region in an expanded state in response to a trigger operation on the call invitation prompt; and displaying the call invitation information in the notification region in the expanded state.

The notification region is a region configured for notifying the call invitation information on the group session page. An area covered on the group session page by the notification region in the collapsed state is greater than an area covered on the group session page by the notification region in the expanded state.

Specifically, after receiving the call invitation information transmitted by the third instant messaging application, the first terminal displays the notification region in the collapsed state on the group session page, and displays the call invitation prompt in the notification region in the collapsed state on the group session page. The call invitation prompt points to the call invitation information transmitted by the third instant messaging application. Further, the first terminal may expand the notification region in the collapsed state into the notification region in the expanded state in response to a trigger operation on the call invitation prompt in the notification region in the collapsed state, and display the call invitation information in the notification region in the expanded state.

In an embodiment, referring to FIG. 7 again, after receiving the call invitation information transmitted by the third instant messaging application, the first terminal displays a notification region 703a in the collapsed state on the group session page 703, and displays a call invitation prompt, that is, “3 persons are in a voice call of A”, in the notification region 703a in the collapsed state on the group session page 703. The call invitation prompt points to the call invitation information transmitted by the third instant messaging application. In response to a trigger operation on the call invitation prompt in the notification region 703a in the collapsed state, the first terminal may expand the notification region 703a in the collapsed state into a notification region 704a in the expanded state on the group session page 704, and display the call invitation information in the notification region in the expanded state. The first terminal may add, in response to a trigger operation of the first communication user on the call invitation information displayed in the notification region 704a in the expanded state, the first communication user to the virtual room designated by the third communication user, and participate in the network call in the virtual room designated by the third communication user.

In the foregoing embodiment, the call invitation prompt is displayed in the notification region in the collapsed state on the group session page, so that richness of content displayed on the group session page can be ensured when it is ensured that a network call invitation is notified in time. In response to a trigger operation for the call invitation prompt, the notification region in the collapsed state is expanded into the notification region in the expanded state, and the call invitation information is displayed in the notification region in the expanded state, so that the first communication user can trigger and join the virtual room designated by the third communication user conveniently, thereby providing a manner in which richness of content displayed on the group session page can be taken into consideration, and efficiency for a multi-person network call can be improved.

In an embodiment, the call invitation information is displayed as a call invitation native card on the group session page of the interworking group; and the adding, in response to a trigger operation performed by the first communication user on the call invitation information displayed on the group session page, the first communication user to the virtual room designated by the third communication user, and participating in a network call in the virtual room designated by the third communication user includes: adding, in response to a trigger operation performed by the first communication user on the call invitation native card displayed on the group session page, the first communication user to the virtual room designated by the third communication user, and participating, by using the network call engine integrated in the first instant messaging application, in a network call in the virtual room designated by the third communication user.

The call invitation native card is a container that is native to the first instant communication application and that is configured for carrying information for inviting the third communication user to participate in the network call.

Specifically, the first communication user may perform a trigger operation on the call invitation native card displayed on the group session page, and further, the first terminal may add the first communication user to the virtual room designated by the third communication user in response to the trigger operation performed by the first communication user on the call invitation native card displayed on the group session page. The first terminal may participate in the network call in the virtual room designated by the third communication user by using the network call engine integrated in the first instant messaging application. The first communication user and the third communication user may perform a network call in the virtual room designated by the third communication user.

In an embodiment, still referring to FIG. 7, the call invitation information is displayed as a call invitation native card 704b on the group session page 704 of the interworking group. The first communication user may perform a trigger operation on the call invitation native card 704b displayed on the group session page 704, and the first terminal may add the first communication user to the virtual room designated by the third communication user in response to the trigger operation of the first communication user on the call invitation native card 704b displayed on the group session page 704, to participate in the network call.

In the foregoing embodiment, by using the call invitation native card displayed on the group session page, and triggering the call invitation native card, the first communication user is directly added to the virtual room designated by the third communication user, to participate in a multi-person network call, thereby further improving efficiency of a multi-person network call.

In an embodiment, the network call method further includes: displaying at least one outside-group communication user in response to a sharing operation triggered for the virtual room; the outside-group communication user being a communication user outside the interworking group; and transmitting, in response to a selection operation on displayed at least one outside-group communication user, join-group call invitation information to the outside-group communication user selected by the selection operation, the join-group call invitation information being configured for indicating the selected outside-group communication user to join the virtual room, and participate in the network call.

Specifically, the first communication user may perform a sharing operation on the virtual room, and the first terminal may display at least one outside-group communication user outside the interworking group in response to the sharing operation triggered on the virtual room. The first communication user may perform a selection operation on the outside-group communication user, and the first terminal may transmit, in response to the selection operation on the displayed at least one outside-group communication user, the join-group call invitation information to each outside-group communication user selected by the selection operation, so that each outside-group communication user selected by the selection operation can join the virtual room based on the join-group call invitation information, and participate in the network call.

In an embodiment, the first terminal may display an outside-group communication user page in response to a sharing operation triggered for the virtual room, and display at least one outside-group communication user on an outside-group communication user page. The outside-group communication user page is a page configured for displaying the outside-group communication user of the interworking group.

In the foregoing embodiment, the virtual room triggered to be created in the group is directly shared outside the group, so as to invite communication users outside the group to participate in a network call together, thereby further improving efficiency of a multi-person network call.

In an embodiment, the displaying at least one outside-group communication user in response to a sharing operation triggered for the virtual room includes: displaying an outside-group communication user page in response to the sharing operation triggered for the virtual room; and displaying, on the outside-group communication user page, at least one outside-group communication user having a social relationship with the first communication user.

In an embodiment, the first terminal may display an outside-group communication user page in response to a sharing operation triggered for the virtual room, and display, in a form of a list on the outside-group communication user page, at least one outside-group communication user having a social relationship with the first communication user. The outside-group communication users in the list may be randomly arranged, or may be arranged according to a preset rule. For example, arrangement may be performed according to features of object identifiers of the outside-group communication users.

In the foregoing embodiment, after the sharing operation is triggered for the virtual room, the outside-group communication user page is displayed, and the at least one outside-group communication user having the social relationship with the first communication user is displayed on the outside-group communication user page, so as to select an outside-group communication user needing to be invited to participate in the network call together, thereby further improving efficiency of a multi-person network call.

In an embodiment, the displaying, on the outside-group communication user page, at least one outside-group communication user having a social relationship with the first communication user includes: presenting a default first tab on the outside-group communication user page, and displaying, in the first tab, at least one outside-group communication user having a social relationship with the first communication user; switching the first tab to a second tab in response to a tab switching operation triggered on the outside-group communication user page; and displaying, in the second tab, at least one outside-group communication user that does not have the social relationship with the first communication user, and participates in a historical cooperation event with the first communication user.

The first tab is an active region that is on the outside-group communication user page and that is configured for carrying the outside-group communication user having the social relationship with the first communication user. The second tab is an active region that is on the outside-group communication user page and that is configured for carrying an outside-group communication user having no social relationship with the first communication user and participating in a historical cooperation event with the first communication user. Only content carried in the first tab or the second tab can be displayed on the outside-group communication user page at the same time. The first tab and the second tab may be switched to each other. The historical cooperation event is a cooperation event that occurs in historical time. The historical time is time before the sharing operation is triggered for the virtual room.

Specifically, the first terminal may present a default first tab on the outside-group communication user page, and display, in the first tab, at least one outside-group communication user having a social relationship with the first communication user. The outside-group communication user displayed in the first tab has a social relationship with the first communication user. The first communication user may perform a switching operation on the first tab. Further, the first terminal may switch the first tab to a second tab in response to a tab switching operation triggered on the outside-group communication user page; and display, in the second tab, at least one outside-group communication user that does not have the social relationship with the first communication user, and participates in a historical cooperation event with the first communication user. The outside-group communication user and the first communication user displayed in the second tab have joined the same historical cooperation event.

In an embodiment, the historical cooperation event may be a historical document cooperation event. In the second tab, the first terminal may display at least one outside-group communication user having no social relationship with the first communication user and participating in the historical document cooperation event with the first communication user. The outside-group communication user and the first communication user displayed in the second tab have operated the same document in historical time.

In an embodiment, the historical cooperation event may be a historical schedule cooperation event. In the second tab, the first terminal may display at least one outside-group communication user having no social relationship with the first communication user and participating in the historical schedule cooperation event with the first communication user. The outside-group communication user and the first communication user displayed in the second tab have operated the same schedule in historical time.

In an embodiment, the historical cooperation event may be a historical conference cooperation event. In the second tab, the first terminal may display at least one outside-group communication user having no social relationship with the first communication user and participating in the historical conference cooperation event with the first communication user. The outside-group communication user and the first communication user displayed in the second tab have joined the same conference in historical time.

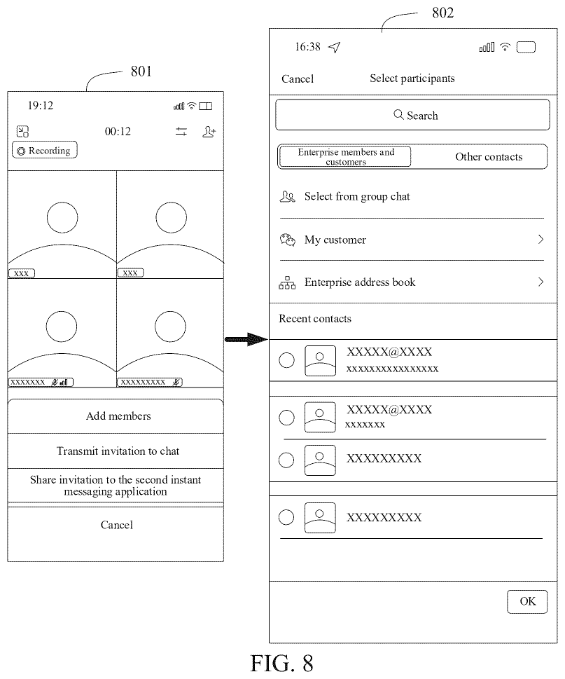

In an embodiment, as shown in FIG. 8, the first terminal may display, in response to a sharing operation triggered for a call interface 801 representing the virtual room, a sharing control configured for triggering sharing, for example, a sharing control such as adding member, transmitting invitation to chat, and sharing invitation to second instant messaging application. In response to a trigger operation for the share control, an outside-group communication user page 802 is displayed, a default first tab, that is, “enterprise members and customers”, is presented on the outside-group communication user page 802, and at least one outside-group communication user having a social relationship (that is, a friendship) with the first communication user is displayed on the first tab. The first communication user may perform a switching operation on the first tab. Further, the first terminal may switch the first tab to a second tab, that is, “other contacts”, in response to a tab switching operation triggered on the outside-group communication user page 802; and display, in the second tab, at least one outside-group communication user that does not have the social relationship with the first communication user, and participates in a historical cooperation event with the first communication user.

In the foregoing embodiment, after the sharing operation is triggered for the virtual room, the default first tab is presented on the outside-group communication user page, and the outside-group communication user having the social relationship with the first communication user is displayed in the first tab, so as to quickly search for and select an outside-group communication user needing to be invited to participate in the network call and having the social relationship with the first communication user. Further, the first tab is switched to the second tab, and the outside-group communication user having no social relationship with the first communication user and also participating in the historical cooperation event with the first communication user is displayed in the second tab, so as to quickly search for and select an outside-group communication user having no social relationship with the first communication user and also participating in the historical cooperation event with the first communication user and needing to be invited to participate in the network call, thereby further improving efficiency of a multi-person network call.

In an embodiment, the transmitting, in response to a selection operation on displayed at least one outside-group communication user, join-group call invitation information to the outside-group communication user selected by the selection operation includes: transmitting, in response to the selection operation on the displayed at least one outside-group communication user, the join-group call invitation information to the outside-group communication user selected by the selection operation when a quantity of communication users in the virtual room is less than or equal to a preset object upper limit; and displaying, in response to the selection operation on the displayed at least one outside-group communication user, prompt information configured for representing a failure in selecting a communication user when the quantity of communication users in the virtual room is greater than the preset object upper limit.

Specifically, the first terminal may compare a quantity of communication users in the virtual room with a preset object upper limit in response to a selection operation on the displayed at least one outside-group communication user. When the quantity of communication users in the virtual room is less than or equal to the preset object upper limit, the first terminal may transmit the join-group call invitation information to the outside-group communication user selected by the selection operation. When the quantity of communication users in the virtual room is greater than the preset object upper limit, the first terminal may display prompt information configured for representing a failure in selecting a communication user.

In an embodiment, when the quantity of communication users in the virtual room is greater than the preset object upper limit, the first terminal may display prompt information configured for representing that selection of the communication user fails and the virtual room is full.

In the foregoing embodiment, the quantity of communication users participating in the network call is limited, that is, when the quantity of communication users participating in the network call is greater than the preset object upper limit, selection of the outside-group communication user is limited, so that excessive communication users can be prevented from participating in the network call at the same time, thereby improving call quality of a multi-person network call.

In an embodiment, the network call method further includes: displaying a call interface of the network call; the call interface including a member region and a control region that are displayed on the same screen; the member region being configured for displaying an identification image of a communication user participating in the network call; and the control region being configured for controlling the network call; and increasing an area of the member region and decreasing an area of the control region when a quantity of communication users participating in the network call exceeds a quantity of identification images able to be accommodated in the member region; the member region with an increased area being configured for displaying more identification images than the quantity of identification images.

Specifically, the first terminal may display the call interface of the network call, and compare the quantity of communication users participating in the network call with a quantity of identification images able to be accommodated in the member region in the call interface. When the quantity of communication users participating in the network call exceeds the quantity of identification images able to be accommodated in the member region, the area of the member region is increased, and the area of the control region in the call interface is decreased. The first terminal may display more identification images than the quantity of identification images in the member region with an increased area.

In an embodiment, the control region is configured for displaying a plurality of control controls for controlling a network call. A spacing between control controls in the control region with a decreased area is less than a spacing between control controls accommodated in the control region before the area is decreased.

In an embodiment, the control region is configured for displaying a plurality of control controls for controlling a network call. An area covered by each control control in the call interface in the control region with a decreased area is smaller than an area covered by each control control in the call interface that is accommodated before the area of the control region is decreased.

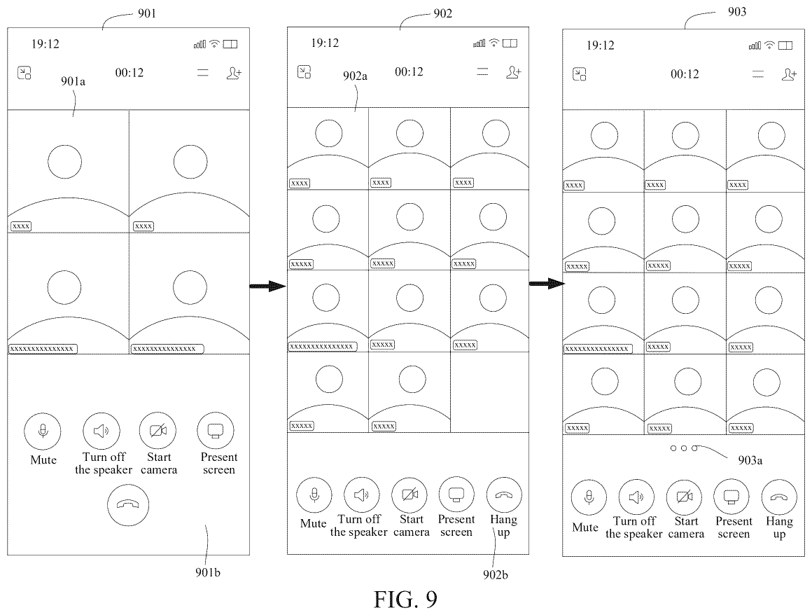

In an embodiment, as shown in FIG. 9, the first terminal may display a call interface 901 of a network call. The call interface 901 includes a member region 901a and a control region 901b that are presented on the same screen. When the quantity of communication users participating in the network call exceeds the quantity of identification images able to be accommodated in the member region 901a in the call interface 901, the area of the member region is increased in the call interface 902, to obtain a member region 902a with an increased area, and the area of the control region is decreased in the call interface 902, to obtain a control region 902b with a decreased area.

In the foregoing embodiment, if the quantity of communication users participating in the network call exceeds the quantity of identification images able to be accommodated in the member region, the area of the member region in the call interface is increased, the area of the control region in the call interface is decreased, and more identification images than the quantity of identification images are displayed in the member region with an increased area, so that identification images of communication users participating in the network call can be presented on the same page as many as possible, thereby saving computer resources.

In an embodiment, a quantity of lines formed by arranging control controls in the control region with a decreased area is smaller than a quantity of lines formed by arranging control controls accommodated before the area of the control region is decreased.

In an embodiment, the control region in the call interface is configured for displaying a plurality of control controls for controlling a network call, for example, control controls such as “mute”, “turn off speaker”, “open camera”, “present screen”, and “hang up”. The quantity of lines includes a quantity of rows. The quantity of rows formed by arranging the control controls in the control region 902b with a decreased area in the call interface 902 is less than the quantity of rows formed by arranging the control controls accommodated in the call interface 901 before the area of the control region (that is, 901b) is decreased.

In an embodiment, the control region is configured for displaying a plurality of control controls for controlling a network call. The quantity of lines includes a quantity of columns. A quantity of columns formed by arranging control controls in the control region with a decreased area is smaller than a quantity of columns formed by arranging control controls accommodated before the area of the control region is decreased.

In the foregoing embodiment, the control region in the call interface is configured for displaying control controls. The quantity of lines formed by arranging the control controls in the control region with a decreased area is limited to be less than the quantity of lines formed by arranging the control controls before the area of the control region is decreased, so that it can be ensured that the quantity of control controls is not decreased while the area of the control region is decreased, thereby better ensuring control over a network call, and further improving network call efficiency.

In an embodiment, the network call method further includes: displaying a page turning control when the quantity of communication users participating in the network call exceeds the quantity of identification images able to be accommodated in the member region with an increased area, and displaying a page of identification images able to be accommodated in the member region with an increased area; and displaying a next page of identification images in the member region with an increased area in response to a trigger operation on the page turning control, identification images displayed on different pages belonging to different communication users.

The page turning control is configured to control, in the call interface of the network call, the identification image of the communication user to turn pages.

Specifically, the first terminal may compare the quantity of communication users participating in the network call with the quantity of identification images able to be accommodated in the member region with an increased area. The first terminal may display a page turning control when the quantity of communication users participating in the network call exceeds the quantity of identification images able to be accommodated in the member region with an increased area, and display a page of identification images able to be accommodated in the member region with an increased area. The first communication user may perform a trigger operation on the page turning control, and the first terminal may display a next page of identification images in the member region with an increased area in response to the trigger operation on the page turning control. Identification images displayed on different pages belong to different communication users.

In an embodiment, still referring to FIG. 9, when the quantity of communication users participating in the network call exceeds the quantity of identification images able to be accommodated in the member region 902a with an increased area, the first terminal may display a page turning control 903a in a call interface 903, and display a page of identification images able to be accommodated in the member region with an increased area in the call interface 903. The first communication user may perform a trigger operation on the page turning control 903a, and the first terminal may display a next page of identification images in the member region with an increased area in the call interface 903 in response to the trigger operation on the page turning control 903a.

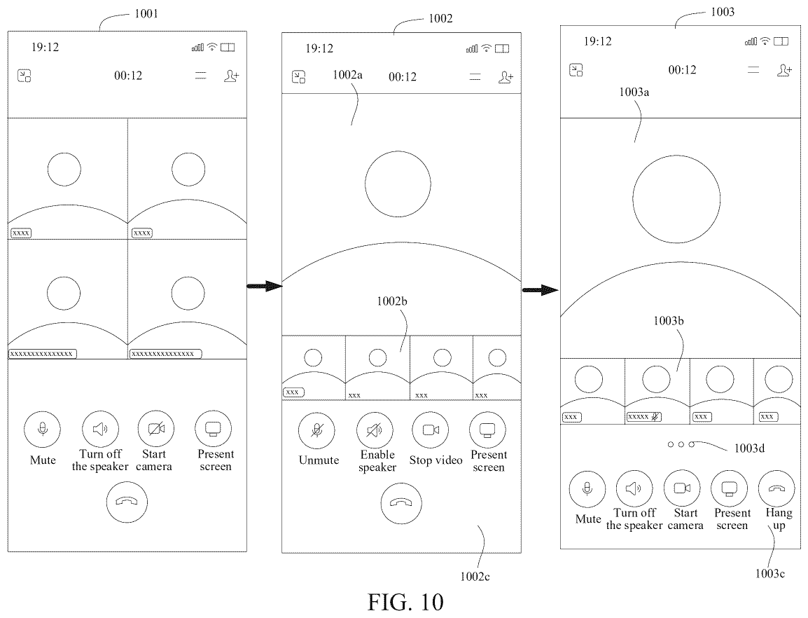

In an embodiment, as shown in FIG. 10, in response to a trigger operation of the first communication user on an identification image of a communication user on a call interface 1001, the terminal may zoom in and display, on the call interface 1002, an identification image of the triggered communication user in an image zoom-in area 1002a, zoom out and display, on an image zoom-out area 1002b, an identification image of a communication user that is not triggered, and decrease an area of a control region 1002c. When the quantity of communication users participating in the call is greater than the preset display quantity, the identification image of the triggered communication user is kept being zoomed in and displayed in the image zoom-in area 1003a on the call interface 1003, and the identification image of the communication user that is not triggered is zoomed out and displayed in the image zoom-out area 1003b, so as to further decrease the area of the control region 1003c, and display the page turning control 1003d. The first communication user may perform a trigger operation on the page turning control 1003d, and the first terminal may display a next page of identification images in the image zoom-out area 1003b of the call interface in response to the trigger operation on the page turning control 1003d.

In the foregoing embodiment, when the quantity of communication users participating in the network call exceeds the quantity of identification images able to be accommodated in the member region with an increased area, the page turning control is displayed, and a page of identification images able to be accommodated is displayed in the member region with an increased area. Further, by triggering the page turning control, a next page of identification images may be displayed in the member region with an increased area. All the communication users participating in the network call may be viewed in the call interface, so as to manage the network call easily, and further improve efficiency of a multi-person network call.

In an embodiment, the network call method further includes: displaying a screen sharing control for the network call; establishing, in response to a trigger operation for the screen sharing control, a screen presentation connection to the network call engine integrated in the second instant messaging application by using the network call engine integrated in the first instant messaging application; and transmitting, based on the screen presentation connection, a screen picture collected by the first instant messaging application.

Specifically, the first terminal may display a screen sharing control for the network call. The first communication user may perform a trigger operation on the screen sharing control, and further, the first terminal may establish, in response to a trigger operation for the screen sharing control, a screen presentation connection to the network call engine integrated in the second instant messaging application by using the network call engine integrated in the first instant messaging application. The first terminal may collect a local screen picture by using the first instant messaging application, and transmit the collected screen picture to the second instant messaging application based on the screen presentation connection, so as to implement screen sharing between the first instant messaging application and the second instant messaging application.

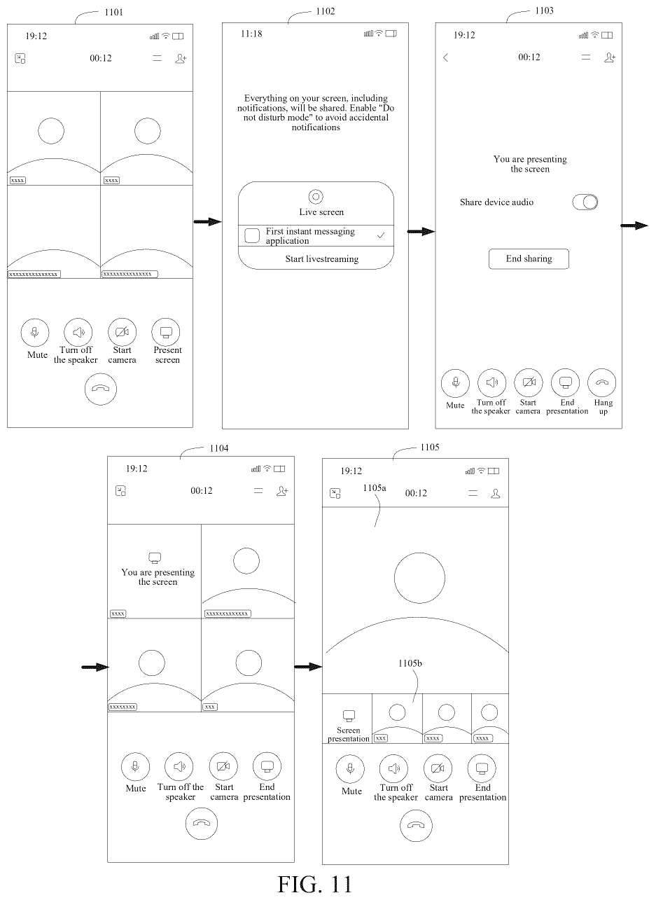

In an embodiment, as shown in FIG. 11, the first terminal may display, in a call interface 1101, a screen sharing control for a network call, that is, a “presentation screen”. The first communication user may perform a trigger operation on the screen sharing control, and the first terminal may display a screen sharing starting page 1102 in response to the trigger operation on the screen sharing control. The first terminal may display a screen sharing setting page 1103 in response to a trigger operation on a “start livestreaming” control on the screen sharing starting page 1102. Whether audio is synchronously shared may be set on the screen sharing setting page 1103. After a screen sharing state is entered, the first terminal may switch the identification image of the first communication user on the call interface 1104 to state information representing screen presentation, that is, “you are presenting the screen”. In response to a trigger operation performed by the first communication user on an identification image of a communication user, the first terminal may zoom in and display, in an image zoom-in area 1105a of a call interface 1105, an identification image of the communication user that is triggered, and zoom out and display, in an image zoom-out area 1105b, an identification image of a communication user that is not triggered.

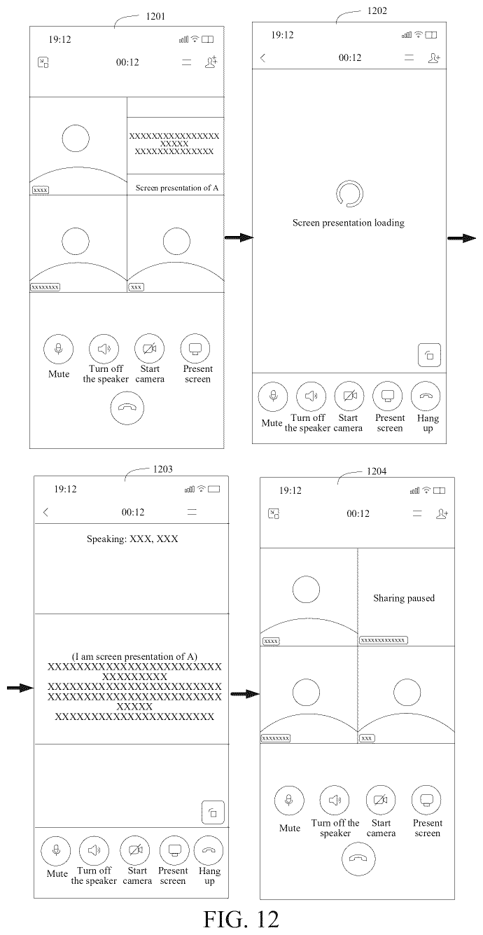

In an embodiment, as shown in FIG. 12, when a third communication user A in the interworking group shares a screen, the first terminal may switch, on a call interface 1201, an identification image of the third communication user A to state information representing screen presentation, that is, “screen presentation of A”. In response to a trigger operation for the state information representing the screen presentation, the first terminal may display a screen presentation loading page 1202. After loading of the presentation screen is completed, the first terminal may display the presentation screen of the third communication user A on a screen sharing page 1203. After the third communication user A suspends sharing the screen, the first terminal may display, on a call interface 1204, state information representing that the third communication user A suspends screen presentation, that is, “sharing is suspended”.

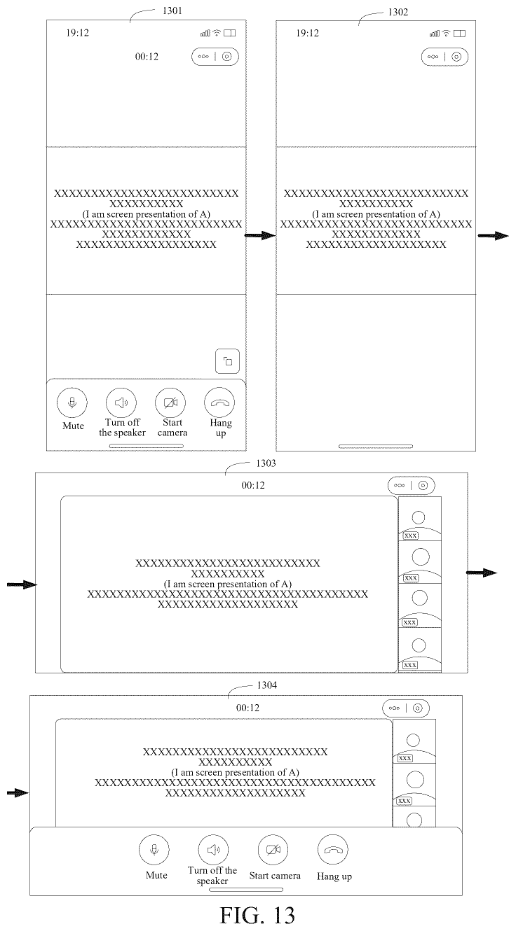

In an embodiment, as shown in FIG. 13, the second communication user in the interworking group may also receive screen presentation shared by the third communication user. The second terminal running the second instant messaging application may display the presentation screen of the third communication user A on a screen sharing page 1301 by using the child application. When the presentation screen of the third communication user A is entered, and the screen sharing page is not triggered within preset time, the second terminal may support displaying a screen sharing page 1302 in full screen. When it is monitored that the second terminal is in a landscape mode, the second terminal may support displaying the screen shared page 1303 in a landscape mode. In response to a trigger operation for the screen sharing page, the second terminal may display a control control for a call on the screen sharing page 1304.

In the foregoing embodiment, in a process of a network call, a screen presentation connection is established between the first instant messaging application and the second instant messaging application, so that a screen picture collected by the first instant messaging application can be transmitted to the second instant messaging application, thereby implementing screen sharing, thereby further improving efficiency of a network call.

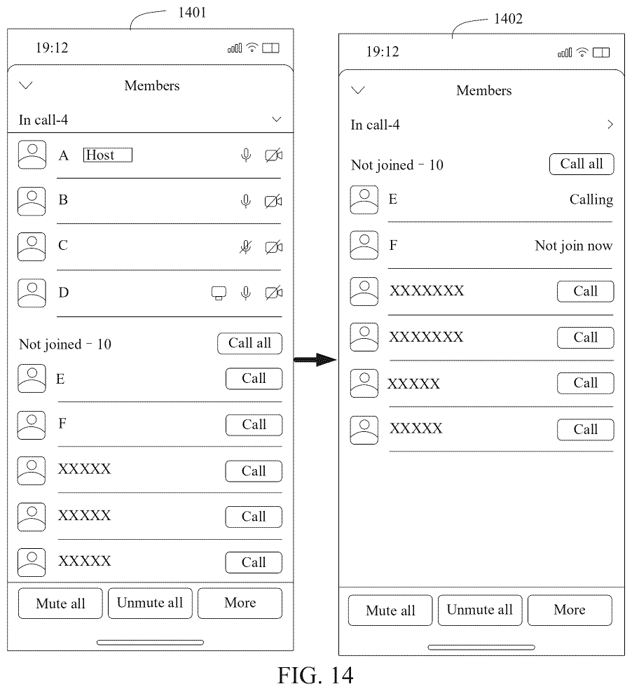

In an embodiment, as shown in FIG. 14, the first communication user (that is, the host) initiating a call may manage communication users in the interworking group based on a member management page 1401 displayed by the first terminal. Specifically, the first communication user may manage a multimedia function permission, for example, permissions such as turning on microphone and starting video, for the communication user participating in the network call. The first communication user may further make a call to a communication user that does not participate in the network call in the member management page 1401. Referring to the member management page 1402 displayed by the first terminal, the first communication user may collapse related information of a communication user that has participated in the network call, and may make, in the member management page 1402, a call to a communication user that has not participated in the network call.

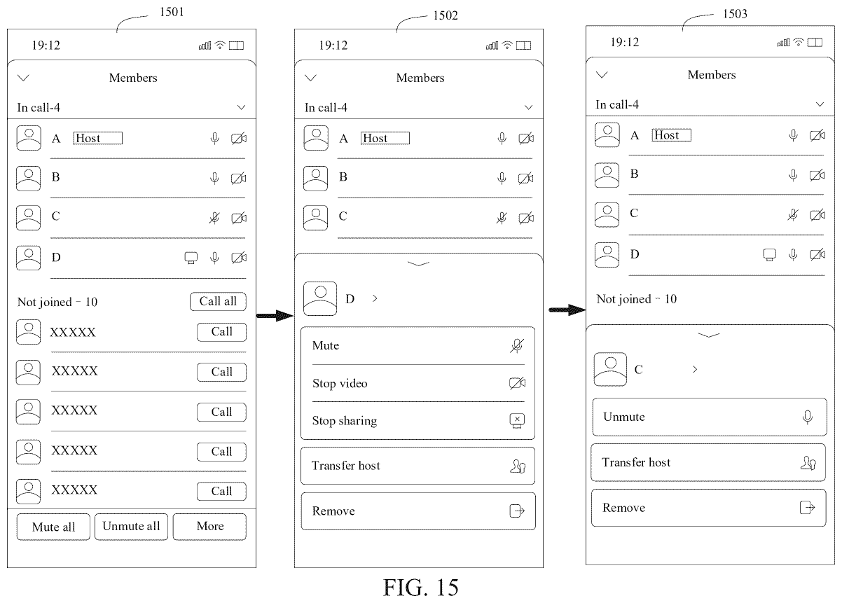

In an embodiment, as shown in FIG. 15, in response to a call operation of the first communication user on a third communication user D on a member management page 1501, the first terminal may display a call setting region for the third communication user D on a member management page 1502. Permission setting may be performed on a mute state, a video starting state, a screen presentation state, host transfer, call removal, and the like of the third communication user D in the call setting region. In addition, the first terminal may display a call setting region for a second communication user C on a member management page 1503 in response to a call operation of the first communication user for the second communication user C on the member management page 1501. Permission setting may be performed on a mute state, host transfer, call removal, and the like of the second communication user C in the call setting region.

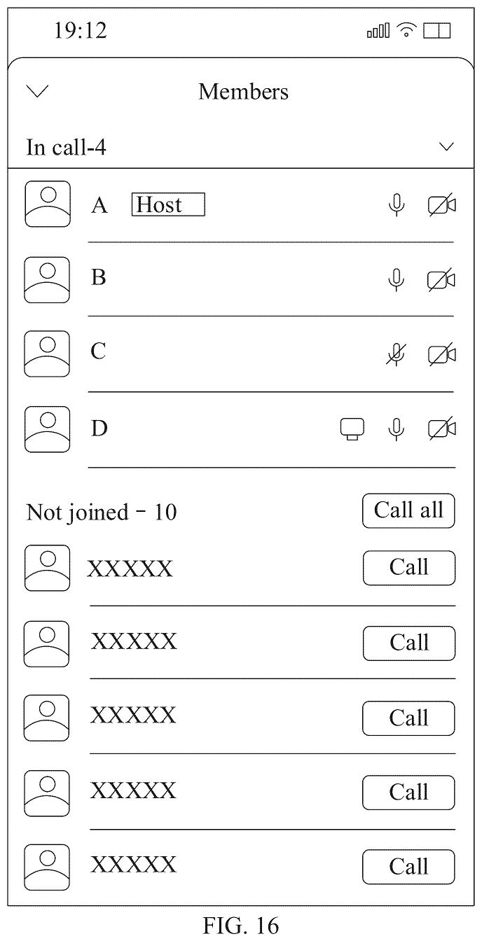

In an embodiment, as shown in FIG. 16, when the first communication user enters the virtual room designated by the third communication user, the third communication user initiating or sharing a call is a host, and the first communication user may view a call status and a multimedia function permission status of each communication user in the interworking group on a member display page.

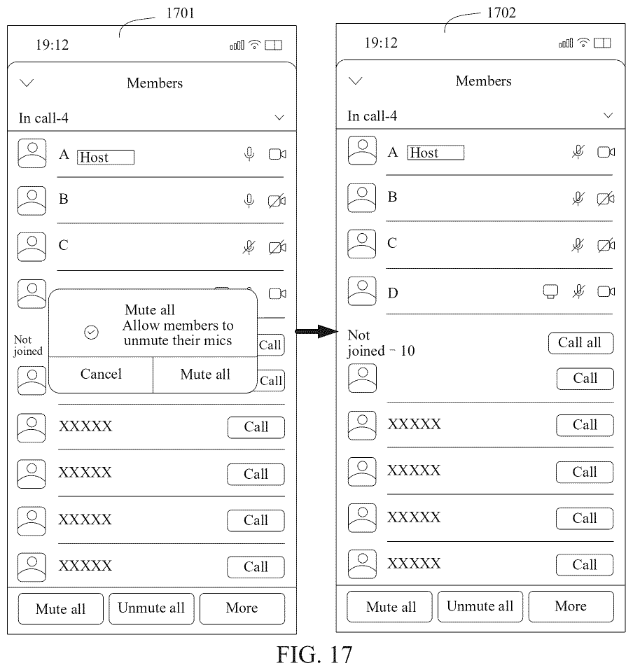

In an embodiment, as shown in FIG. 17, the first communication user (that is, the host) initiating a call may perform mute management on communication users in the interworking group based on a member management page 1701 displayed by the first terminal. Specifically, in response to a trigger operation of the first communication user on a “mute all” control on the member management page 1701, the first terminal may display, on the member management page 1701, a prompt pop-up window indicating to mute all members. Permission setting may be performed on whether to allow the members to unmute themselves in the prompt pop-up window. In response to a trigger operation performed by the first communication user on the “mute all” control in the prompt pop-up window, states of microphones of all members are displayed as the mute state on the member management page 1702.

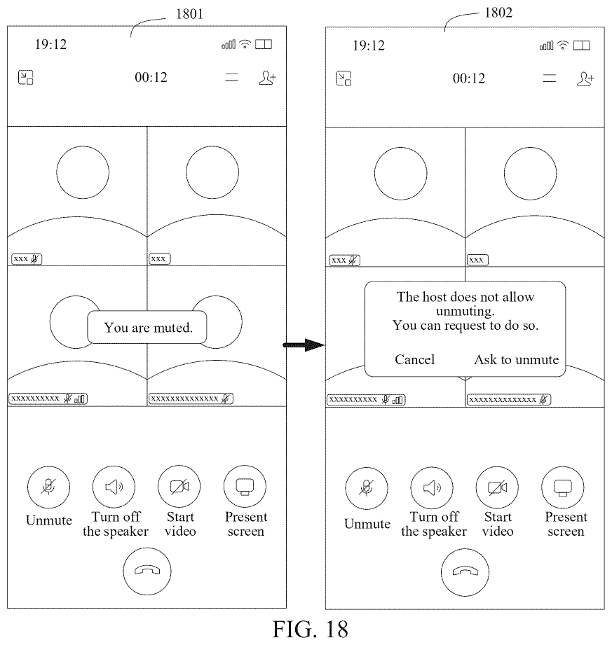

In an embodiment, as shown in FIG. 18, when the first communication user enters the virtual room designated by the third communication user, the third communication user initiating or sharing a call is a host. After the host mutes the first communication user, the first terminal may display, on a call interface 1801, prompt information indicating muted, that is, “the host has muted you”. In response to a trigger operation of the first communication user on an “unmute” control on the call interface 1801, the first terminal may display prompt information representing a mute permission release application on a call interface 1802. The first communication user may apply to the third communication user for unmuting based on the prompt information representing the mute permission release application.

In an embodiment, the network call method further includes: displaying, when the second communication user is in a permission limited state and when receiving a permission limitation release request transmitted by the second instant messaging application, a floating bubble that indicates the permission limitation release request; displaying, in response to a trigger operation for the floating bubble, a request processing page for the permission limitation release request; and displaying a permission management option for the permission limitation release request on the request processing page; the permission management option being configured for triggering permission processing on the permission limitation release request.

The second communication user in the permission limited state cannot have a control permission to freely enable a multimedia communication function. The multimedia communication function may include at least one of turning on microphone, starting video, or the like. The permission limitation release request is a computer instruction requesting to release an enabling limitation for the multimedia communication function. A floating bubble is a message container supporting floating display on a page. The request processing page is a page on which the permission limitation release request is processed.

Specifically, the first communication user may limit the permission of the second communication user to enable the multimedia communication function. When the second communication user is in the permission limited state, the second communication user may apply for releasing the permission limitation from the first communication user, and when receiving a permission limitation release request transmitted by the second instant messaging application, the first terminal may display a floating bubble that indicates the permission limitation release request. The first terminal may display, in response to a trigger operation for the floating bubble, a request processing page for the permission limitation release request, and display a permission management option for the permission limitation release request on the request processing page. The first terminal may perform corresponding permission processing on the permission limitation release request in response to a trigger operation for the permission management option.

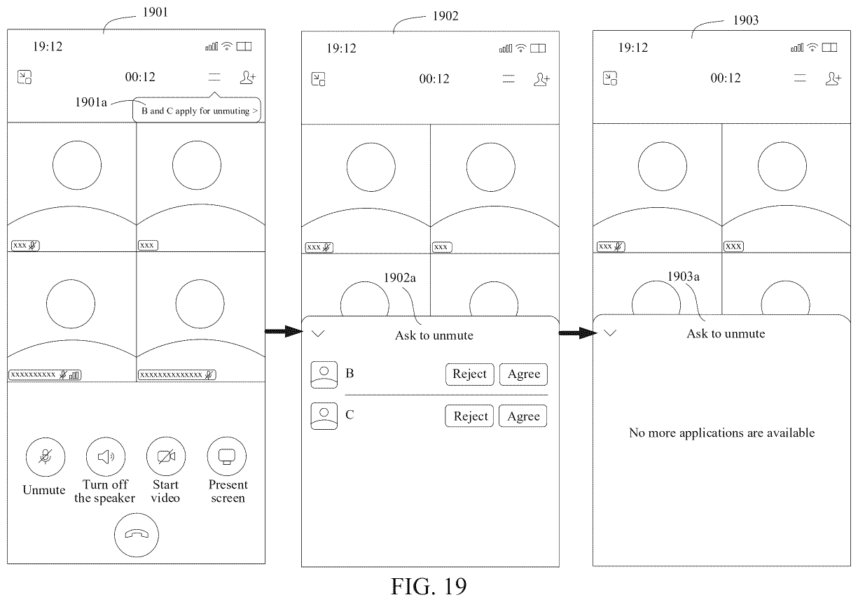

In an embodiment, as shown in FIG. 19, when the second communication user (for example, second communication users B and C) is in a permission limited state, the second communication user may apply to release the permission limitation from the first communication user, and when receiving a permission limitation release request transmitted by the second instant messaging application, the first terminal may display, on a call interface 1901, a floating bubble 1901a indicating the permission limitation release request transmitted by the second communication users B and C. The first terminal may display a request processing page 1902a for the permission limitation release request on the call interface 1902 in response to a trigger operation for the floating bubble 1901a, and display permission management options, that is, “agree” and “reject” controls, for the permission limitation release request on a request processing page 1902a. The first terminal may perform corresponding permission processing on the permission limitation release request in response to a trigger operation for the permission management option. After corresponding permission processing on the permission limitation release request is completed, a request processing page 1903a that indicates no more application prompt information is displayed on the call interface 1903.

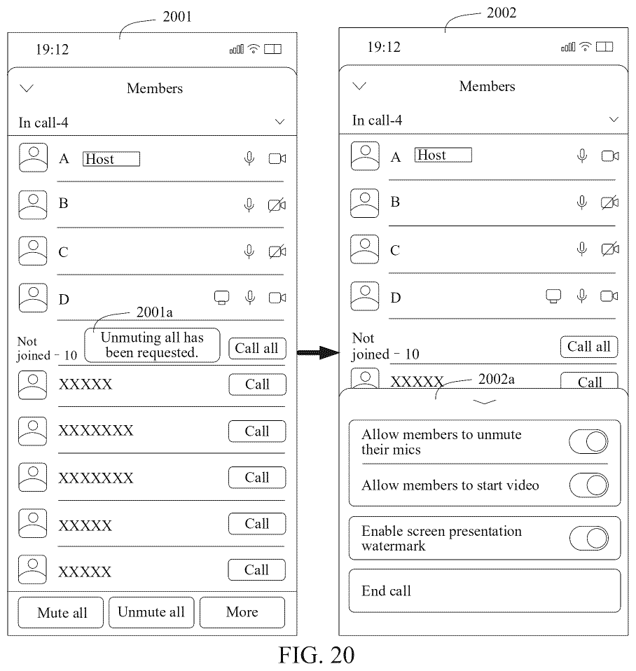

In an embodiment, as shown in FIG. 20, in response to a trigger operation on a “mute all” control on a member management page 2001, the first terminal may display, on the member management page 2001, prompt information 2001a representing that muting all is already performed. In response to a trigger operation for a “more” control in the member management page 2001, the first terminal may display, on a member management page 2002, a management region 2002a configured for performing more management operations. The first communication user may perform permission management on member self-muting, video starting, screen presentation, call status, and the like in the management region 2002a.

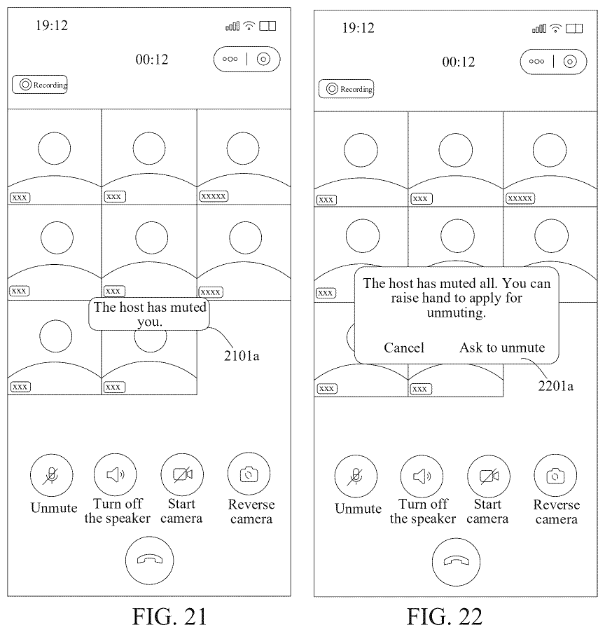

In an embodiment, as shown in FIG. 21, after the first communication user mutes the second communication user, the second terminal running the second instant messaging application may display, on the call interface by using the child application, prompt information 2101a representing muted, that is, “the host has muted you”.

In an embodiment, as shown in FIG. 22, after the first communication user mutes all members in the interworking group including the second communication user, the second terminal running the second instant messaging application may display, on the call interface by using the child application, prompt information 2201a representing that all members are muted, that is, “the host has muted all. You can raise hand to apply for unmuting”. The second communication user may apply for unmuting from the first communication user.

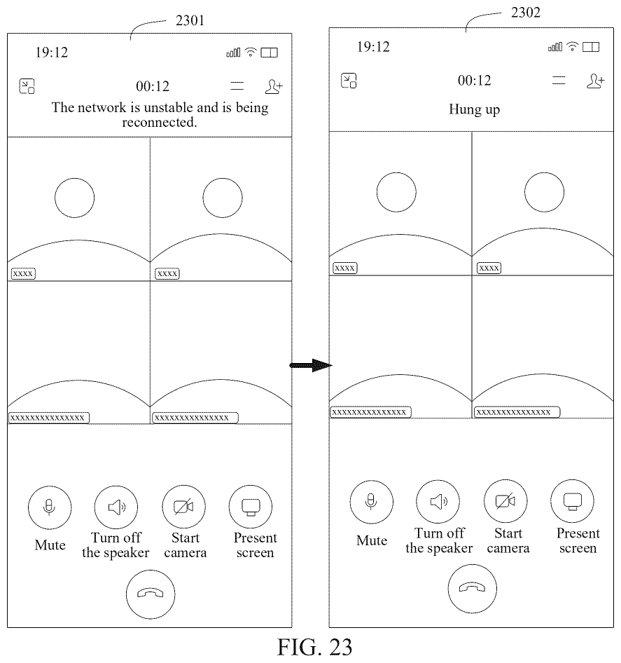

In an embodiment, as shown in FIG. 23, when a network of the first terminal is unstable, the first terminal may display, in a call interface 2301, prompt information indicating that the network is unstable, that is, “the network is unstable and is being reconnected”. The first terminal may respond to a call hung up operation triggered by the first communication user, and display, in a call interface 2302, prompt information indicating “hung up”.

In the foregoing embodiment, when the second communication user is in a permission limited state, and receives the permission limitation release request transmitted by the second instant messaging application, the second communication user may transmit the permission limitation release request of the second communication user to the first communication user in time by displaying the floating bubble indicating the permission limitation release request. Further, the request processing page may be directly entered by triggering the floating bubble, so that the permission limitation release request of the second communication user is processed in time on the request processing page, thereby further improving network call efficiency.

In an embodiment, the virtual room includes a logical room maintained on a first communication platform, and further includes a multimedia room maintained on a second communication platform. The first communication platform is configured to support remote interaction with the first instant messaging application, and the second communication platform is configured to support remote interaction with the second instant messaging application. The logical room is configured to support interaction logic of the virtual room, and the multimedia room is configured to support multimedia interaction of the virtual room.

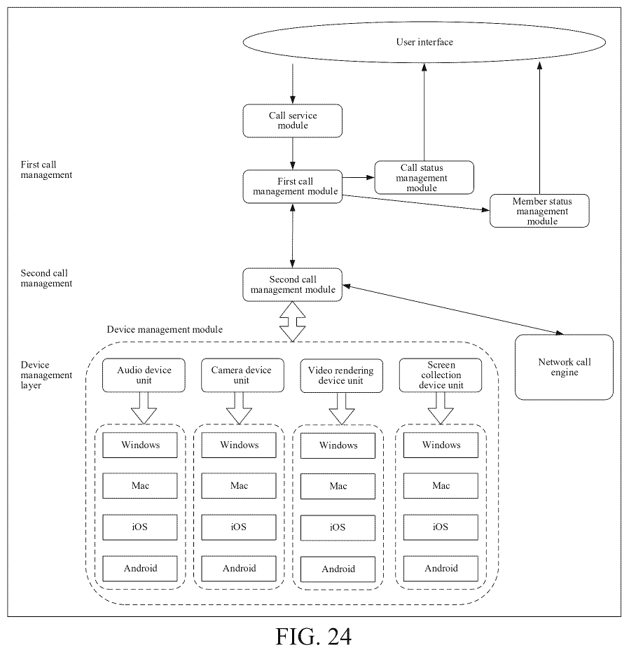

In an embodiment, as shown in FIG. 24, the first instant messaging application in this application is an application with a cross-platform capability. Specifically, the first instant messaging application may be respectively adapted to a plurality of operating systems such as Windows, Mac, iOS, and Android, and run on adapted operating systems in different application program forms. An overall architecture of the first instant messaging application includes a first call management layer, a second call management layer, and a device management layer. The first call management layer includes a user interface, a call service module, a first call management module, a call state management module, and a member state management module. The second call management layer includes a second call management module and a network call engine. The device management layer includes a device management module. The user interface is configured to support user interaction. The device management module includes an audio device unit, a camera device unit, a video rendering device unit, and a screen collection device unit. The call service module is mainly responsible for processing logic such as creating a network call, ringing, and call mutual exclusion. The first call management module is mainly configured to indicate the call state management module to execute virtual room state management logic for a network call, and indicate the member state management module to execute logic such as member state synchronization, call sharing, and screen sharing. The second call management module is mainly responsible for interacting with the network call engine, to implement a cross-application network call and other logic.

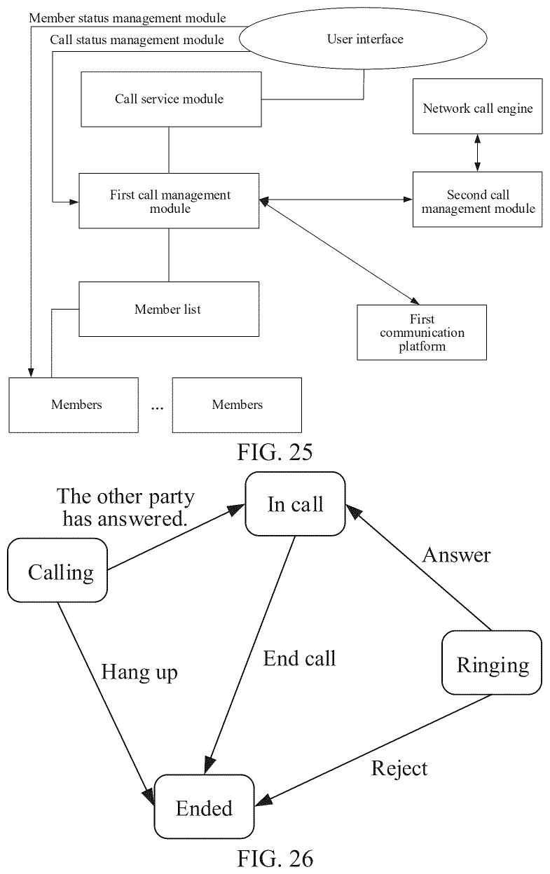

In an embodiment, as shown in FIG. 25, the first communication user may perform interaction based on a user interface, and the first terminal running the first instant messaging application may create a network call by using the call service module, indicate, by using the first call management module, the call state management module to obtain a status of a virtual room, and indicate the member state management module to synchronize statuses of members participating in the network call. The first communication platform supporting remote interaction of the first instant messaging application may be responsible for logic such as ringing, call hung-up, a member not joining a call, active rejection of participation in a call, and call mutual exclusion. The first terminal may interact with the network call engine by using the second call management module, to implement a cross-application network call.

In an embodiment, as shown in FIG. 26, when the first communication user initiates a call to the second communication user, the second communication user may choose to answer or reject the call. If the second communication user answers the call, the cross-application network call is entered. If the first communication user or the second communication user triggers the call to end, the network call is directly ended. If the second communication user rejects the call, the network call for the second communication user is directly ended.

In the foregoing embodiment, a cross-application network call is implemented by using the logic room configured for supporting interaction logic of the virtual room and the multimedia room configured for supporting multimedia interaction of the virtual room, thereby further improving network call efficiency.

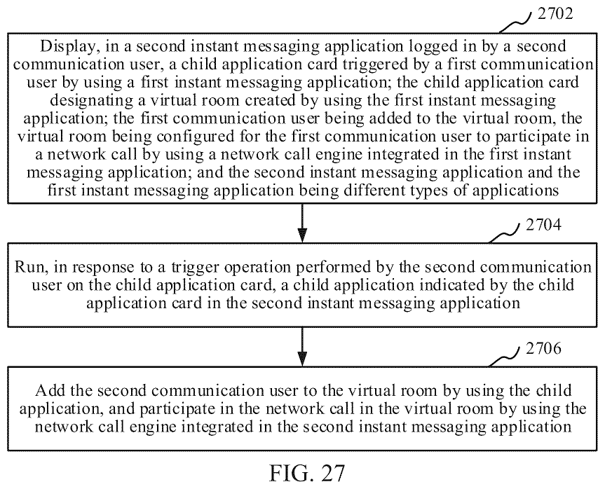

In an embodiment, as shown in FIG. 27, a network call method is provided. The method may be applied to a second terminal running a second instant messaging application to which a second communication user logs in, and includes the following operations:

Operation 2702: Display, in a second instant messaging application to which a second communication user logs in, a child application card that is triggered by a first communication user by using a first instant messaging application; the child application card designating a virtual room created by using the first instant messaging application; the first communication user being added to the virtual room, and the virtual room being configured for the first communication user to participate in a network call by using a network call engine integrated in the first instant messaging application; and the second instant messaging application and the first instant messaging application being different types of applications.

Specifically, the first communication user may trigger a network call in the first instant messaging application, so that the first terminal running the first instant messaging application may create, in response to a call trigger operation triggered by the first communication user in the first instant messaging application, a virtual room configured for a network call, and add the first communication user to the virtual room. After the virtual room to which the first communication user is added has been created, the first terminal may transmit the child application card indicating the virtual room to the second terminal. Further, the second terminal may receive the child application card, and display the child application card in the second instant messaging application to which the second communication user logs in.

Operation 2704: Run, in response to a trigger operation performed by the second communication user on the child application card, a child application indicated by the child application card in the second instant messaging application.

Specifically, the second communication user may perform a trigger operation on the child application card displayed in the second instant messaging application, and the second terminal may run, in response to a trigger operation performed by the second communication user on the child application card, a child application indicated by the child application card in the second instant messaging application.

Operation 2706: Add the second communication user to the virtual room by using the child application, and participate in the network call in the virtual room by using the network call engine integrated in the second instant messaging application.

The network call engine integrated in the first instant messaging application and the network call engine integrated in the second instant messaging application are configured for supporting the same communication protocol for a network call.

Specifically, the second terminal may add the second communication user to the virtual room by using the child application, and participate in the network call in the virtual room by using the network call engine integrated in the second instant messaging application. After the second communication user joins the virtual room, the first terminal may participate in the network call in the virtual room by using the network call engine integrated in the first instant messaging application. The first communication user and the second communication user may perform a cross-application network call in the same virtual room.

In the foregoing network call method, the child application card triggered by the first communication user by using the first instant messaging application is displayed in the second instant messaging application to which the second communication user logs in. The child application card designates a virtual room created by using the first instant messaging application; the first communication user is added to the virtual room, and the virtual room is configured for the first communication user to participate in a network call by using a network call engine integrated in the first instant messaging application; and the second instant messaging application and the first instant messaging application are different types of applications. In response to a trigger operation performed by the second communication user on the child application card, the child application indicated by the child application card is run in the second instant messaging application, and the second communication user is added to the virtual room by using the child application. In the virtual room, the second communication user participates in the network call by using the network call engine integrated in the second instant messaging application. Compared with a conventional call manner in which all call participants can implement a network call only based on the same instant messaging application, in this application, the same network call engine is integrated into instant messaging applications of different types, based on the same network call engine, and instant communication users logging in by using different instant messaging applications are added to the same virtual room by using a child application, so that instant communication users logging in by using different instant messaging applications can perform a cross-application network call in the virtual room, thereby improving network call efficiency, and in particular, improving network call efficiency for a multi-person network call scenario.

In an embodiment, the virtual room includes a logical room maintained on a first communication platform, and further includes a multimedia room maintained on a second communication platform. The first communication platform is configured to support remote interaction with the first instant messaging application, and the second communication platform is configured to support remote interaction with the second instant messaging application. The logical room is configured to support interaction logic of the virtual room, and the multimedia room is configured to support multimedia interaction of the virtual room.

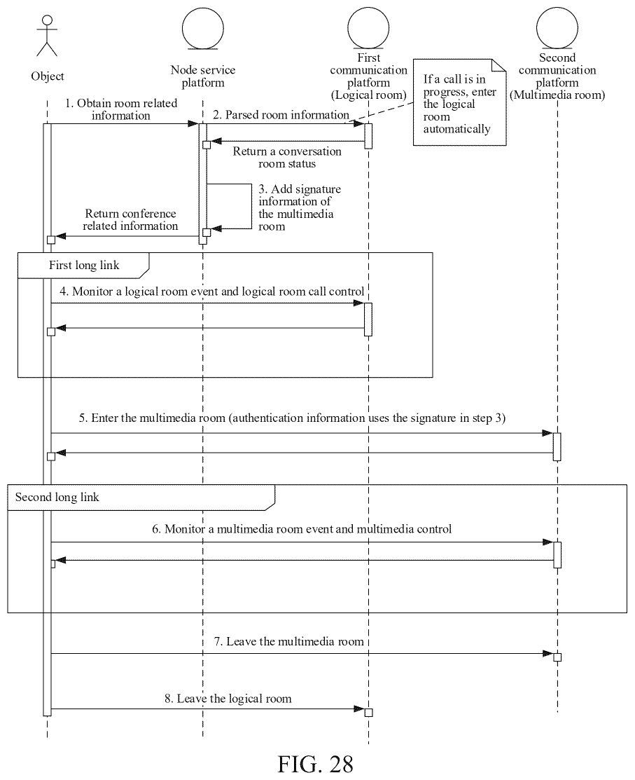

In an embodiment, as shown in FIG. 28, the second communication user may perform a trigger operation on the child application card displayed in the second instant messaging application, and the second terminal may obtain, in response to the trigger operation performed by the second communication user on the child application card, call room information carried in the child application card, and run the child application indicated by the child application card in the second instant messaging application. The second terminal may transmit the call room information to a node service platform by using the child application. The node service platform may parse the call room information, and transmit the call room information obtained through parsing to a first communication platform. The first communication platform may obtain, by using the logical room, state information of the virtual room indicated by the call room information, and return the state information of the virtual room to the node service platform. In a case that it is determined, based on the state information of the virtual room, that the virtual room indicated by the call room information is valid, the node service platform adds signature information of the multimedia room to the call room information, and returns the call room information added with the signature information to the second terminal. The second terminal may monitor the logical room by using a first long link connecting the second terminal and the first communication platform. The second terminal may enter the multimedia room by using the obtained signature information. The second terminal may monitor the multimedia room by using a second long link connecting the second terminal and the second communication platform. In response to a call hung up operation, the second terminal may exit the multimedia room and exit the logical room, to end the network call.

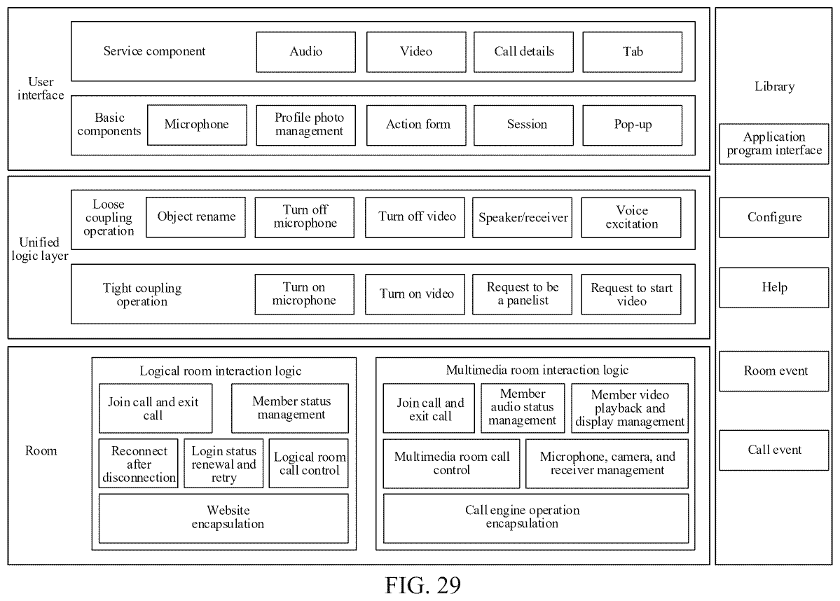

In an embodiment, as shown in FIG. 29, an overall architecture of the second instant messaging application includes a user interface layer, a unified logic layer, a room layer, and a universal library layer. The user interface layer includes a service component and basic components. The service components include an audio component, a video component, a call details component, and a tab component. The basic components include a microphone component, a profile photo management component, an action form component, a session component, and a pop-up component. The user interface layer is configured to implement user interaction. The unified logic layer includes loose coupling operation logic and tight coupling operation logic. Loose coupling operation logic includes object renaming, turning off microphone, closing video, speaker (receiver) mode, and voice excitation. Tight coupling operation logic includes turning on microphone, starting video, request to be a panelist, and request to start video. The room layer includes logical room interaction logic and multimedia room interaction logic. The logical room interaction logic includes call join, call exit, member state management, disconnect, reconnect, login state renewal and retry, logical room call control, and website encapsulation. The multimedia room interaction logic includes call join, call exit, member audio state management, member video playback and display management, multimedia room call control, microphone management, camera management, receiver management, and call engine operation encapsulation. The universal library layer includes an application programming interface component, a configuration component, a help component, a room event management component, and a call event management component.

Because the logical room and the multimedia room are independent of each other, but an operation related to tight coupling in the multimedia room is further limited by the logical room, a unified logical layer needs to be set to manage this type of scenario. The operation related to tight coupling needs the logical room and the multimedia room to cooperate with each other. For example, when the second communication user actively turns on microphone, the second terminal first detects whether the first communication user as a call host limits a microphone turning on permission of the second communication user. In a case that it is determined that the first communication user does not limit the microphone turning on permission of the second communication user (for example, it is determined that the first communication user does not perform mute limitation on the second communication user, and also performs mute limitation on all members in the interworking group), the second terminal may directly turn on the microphone in response to a microphone turning on operation of the second communication user. In a case that it is determined that the first communication user has limited the microphone turning on permission of the second communication user (for example, it is determined that the first communication user has performed mute limitation on the second communication user, and has performed mute limitation on all members in the interworking group), the second terminal prompts the second communication user to first make a permission limitation release application (for example, muting release application). Only after the first communication user agrees on the muting release application, the second communication user can turn on the microphone to speak in the network conference.

In the foregoing embodiment, a cross-application network call is implemented by using the logic room configured for supporting interaction logic of the virtual room and the multimedia room configured for supporting multimedia interaction of the virtual room, thereby further improving network call efficiency.

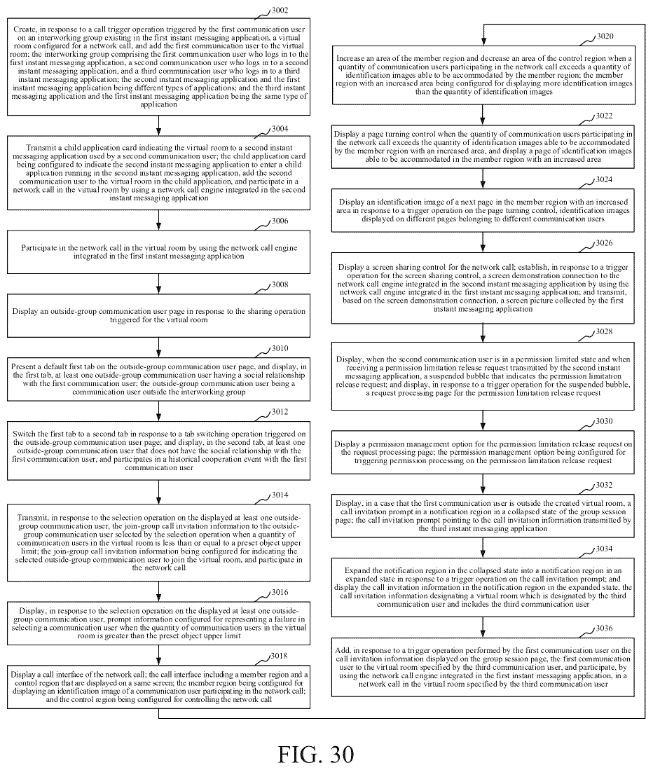

As shown in FIG. 30, in an embodiment, a network call method is provided. The method may be applied to a terminal running a first instant messaging application to which a first communication user logs in. The method specifically includes the following operations:

Operation 3002: Create, in response to a call trigger operation triggered by the first communication user on an interworking group existing in the first instant messaging application, a virtual room configured for a network call, and add the first communication user to the virtual room. The interworking group includes the first communication user logging in to the first instant messaging application, a second communication user logging in to a second instant messaging application, and a third communication user logging in to a third instant messaging application. The second instant messaging application and the first instant messaging application are different types of applications; and the third instant messaging application is the same type of application as the first instant messaging application.

Operation 3004: Transmit a child application card indicating the virtual room to a second instant messaging application used by a second communication user. The child application card is configured to indicate the second instant messaging application to enter a child application running in the second instant messaging application, add the second communication user to the virtual room in the child application, and participate in a network call in the virtual room by using a network call engine integrated in the second instant messaging application.

Operation 3006: Participate in the network call in the virtual room by using the network call engine integrated in the first instant messaging application.

Operation 3008: Display an outside-group communication user page in response to the sharing operation triggered for the virtual room.

Operation 3010: Present a default first tab on the outside-group communication user page, and display, in the first tab, at least one outside-group communication user having a social relationship with the first communication user. The outside-group communication user is a communication user outside the interworking group.

Operation 3012: Switch the first tab to a second tab in response to a tab switching operation triggered on the outside-group communication user page; and display, in the second tab, at least one outside-group communication user that does not have the social relationship with the first communication user, and participates in a historical cooperation event with the first communication user.

Operation 3014: Transmit, in response to the selection operation on the displayed at least one outside-group communication user, the join-group call invitation information to the outside-group communication user selected by the selection operation when a quantity of communication users in the virtual room is less than or equal to a preset object upper limit. The join-group call invitation information is configured for indicating the selected outside-group communication user to join the virtual room, and participate in the network call.

Operation 3016: Display, in response to the selection operation on the displayed at least one outside-group communication user, prompt information configured for representing a failure in selecting a communication user when the quantity of communication users in the virtual room is greater than the preset object upper limit.

Operation 3018: Display a call interface of the network call. The call interface includes a member region and a control region that are displayed on the same screen; the member region is configured for displaying an identification image of a communication user participating in the network call; and the control region is configured for controlling the network call.

Operation 3020: Increase an area of the member region and decrease an area of the control region when a quantity of communication users participating in the network call exceeds a quantity of identification images able to be accommodated in the member region. The member region with an increased area is configured for displaying more identification images than the quantity of identification images.

Operation 3022: Display a page turning control when the quantity of communication users participating in the network call exceeds the quantity of identification images able to be accommodated in the member region with an increased area, and display a page of identification images able to be accommodated in the member region with an increased area.

Operation 3024: Display a next page of identification images in the member region with an increased area in response to a trigger operation on the page turning control, identification images displayed on different pages belonging to different communication users.

Operation 3026: Display a screen sharing control for the network call; establish, in response to a trigger operation for the screen sharing control, a screen presentation connection to the network call engine integrated in the second instant messaging application by using the network call engine integrated in the first instant messaging application; and transmit, based on the screen presentation connection, a screen picture collected by the first instant messaging application.

Operation 3028: Display, when the second communication user is in a permission limited state and when receiving a permission limitation release request transmitted by the second instant messaging application, a floating bubble that indicates the permission limitation release request; and display, in response to a trigger operation for the floating bubble, a request processing page for the permission limitation release request.

Operation 3030: Display a permission management option for the permission limitation release request on the request processing page. The permission management option is configured for triggering permission processing on the permission limitation release request.

Operation 3032: Display, when the first communication user is outside the created virtual room, a call invitation prompt in a notification region in a collapsed state of the group session page. The call invitation prompt points to the call invitation information transmitted by the third instant messaging application.

Operation 3034: Expand the notification region in the collapsed state into a notification region in an expanded state in response to a trigger operation on the call invitation prompt; and display the call invitation information in the notification region in the expanded state. The call invitation information designates a virtual room which is designated by the third communication user and includes the third communication user.

Operation 3036: Add, in response to a trigger operation performed by the first communication user on the call invitation information displayed on the group session page, the first communication user to the virtual room designated by the third communication user, and participate, by using the network call engine integrated in the first instant messaging application, in a network call in the virtual room designated by the third communication user.

This application further provides an application scenario to which the foregoing network call method is applied. Specifically, the network call method may be applied to a scenario of a cross-application multi-person network voice call based on a mini program. The network call in this application may include a network voice call, the child application includes a mini program application, the historical cooperation event includes a historical document cooperation event, the permission limitation status includes a mute permission limited state, and the permission limitation release request includes a muting release request.

Specifically, a terminal may create, in response to a call trigger operation triggered by the first communication user on an interworking group existing in the first instant messaging application, a virtual room configured for a network call, and add the first communication user to the virtual room. The interworking group includes the first communication user logging in to the first instant messaging application, a second communication user logging in to a second instant messaging application, and a third communication user logging in to a third instant messaging application. The second instant messaging application and the first instant messaging application are different types of applications; and the third instant messaging application is the same type of application as the first instant messaging application. A mini program application card indicating a network voice call room is transmitted to the second instant messaging application used by the second communication user; the mini program application card is configured to indicate the second instant messaging application to enter the mini program application, add the second communication user to the network voice call room in the mini program application, and participate in the network voice call by using a network voice call engine integrated in the second instant messaging application in the network voice call room. In the network voice call room, a network voice call engine integrated in the first instant messaging application participates in a network voice call.

The terminal may display an outside-group communication user page in response to a sharing operation triggered for the network voice call room. A default first tab is presented on the outside-group communication user page, and in the first tab, at least one outside-group communication user having a social relationship with the first communication user is displayed. The outside-group communication user is a communication user outside the interworking group. The first tab is switched to a second tab in response to a tab switching operation triggered on the outside-group communication user page. In the second tab, at least one outside-group communication user having no social relationship with the first communication user and participating in the historical document cooperation event with the first communication user may be displayed.

The terminal may transmit, in response to a selection operation on the displayed at least one outside-group communication user, the join-group call invitation information to the outside-group communication user selected by the selection operation when a quantity of communication users in the network voice call room is less than or equal to a preset object upper limit. The join-group call invitation information is configured for indicating the selected outside-group communication user to join the network voice call room, and participate in the network voice call. In response to a selection operation on the displayed at least one outside-group communication user, when the quantity of communication users in the network voice call room is greater than the preset object upper limit, prompt information configured for representing a failure in selecting a communication user is displayed.

The terminal may display a call interface of the network voice call. The call interface includes a member region and a control region that are displayed on the same screen; the member region is configured for displaying an identification image of a communication user participating in the network voice call; and the control region being configured for controlling the network voice call. An area of the member region is increased and an area of the control region is decreased when a quantity of communication users participating in the network call exceeds a quantity of identification images able to be accommodated in the member region. The member region with an increased area is configured for displaying more identification images than the quantity of identification images. A page turning control is displayed when the quantity of communication users participating in the network voice call exceeds the quantity of identification images able to be accommodated in the member region with an increased area, and a page of identification images able to be accommodated in the member region with an increased area is displayed. A next page of identification images is displayed in the member region with an increased area in response to a trigger operation on the page turning control, identification images displayed on different pages belonging to different communication users.

The terminal may display a screen sharing control for the network voice call. In response to a trigger operation for the screen sharing control, a screen presentation connection is established to a network voice call engine integrated in the second instant messaging application by using the network voice call engine integrated in the first instant messaging application, and a screen picture collected by the first instant messaging application is transmitted based on the screen presentation connection.

When the second communication user is in a mute permission limited state and receives a muting release request transmitted by the second instant messaging application, the terminal may display a floating bubble indicating the muting release request. In response to a trigger operation for the floating bubble, a request processing page for the muting release request is displayed. A permission management option for the muting release request is displayed on the request processing page. The permission management option is configured for triggering permission processing on the muting release request.

In a case that the first communication user is outside the created network voice call room, the terminal may display the call invitation prompt in a notification region in a collapsed state of the group session page. The call invitation prompt points to the call invitation information transmitted by the third instant messaging application. The notification region in the collapsed state is expanded into a notification region in an expanded state in response to a trigger operation on the call invitation prompt. The call invitation information is displayed in the notification region in the expanded state. The call invitation information designates a network voice call room designated by the third communication user and including the third communication user. In response to a trigger operation performed by the first communication user on the call invitation information displayed on the group session page, the first communication user is added to the network voice call room designated by the third communication user and participating in the network voice call by using the network voice call engine integrated in the first instant messaging application in the network voice call room designated by the third communication user.

In this application, the same network call engine is integrated in different types of instant messaging applications, based on the same network call engine, and instant communication users logging in by using different instant messaging applications are added, by using a mini program application, to the same network voice call room, so that instant communication users logging in by using different instant messaging applications can perform a cross-application network video call in the network voice call room, thereby improving call efficiency for a multi-person network voice call scenario.

This application further provides another application scenario to which the foregoing network call method is applied. Specifically, the network call method may be applied to a scenario of a cross-application multi-person network video call based on a mini program. The network call in this application may include a network video call, and the child application includes a mini program application. In this application, the same network call engine is integrated in different types of instant messaging applications, based on the same network call engine, and instant communication users logging in by using different instant messaging applications are added, by using a mini program application, to the same network video call room, so that instant communication users logging in by using different instant messaging applications can perform a cross-application network video network call in the network video call room, thereby improving call efficiency for a multi-person network video call scenario.

Although operations in the flowcharts of the foregoing embodiments are displayed in sequence, these operations are not necessarily performed in sequence. Unless otherwise explicitly specified in this application, execution of the operations is not strictly limited, and the operations may be performed in other sequences. Moreover, at least some of the operations in each embodiment may include a plurality of sub-operations or a plurality of stages. The sub-operations or stages are not necessarily performed at the same moment but may be performed at different moments. Execution of the sub-operations or stages is not necessarily sequentially performed, but may be performed alternately with other operations or at least some of sub-operations or stages of other operations.

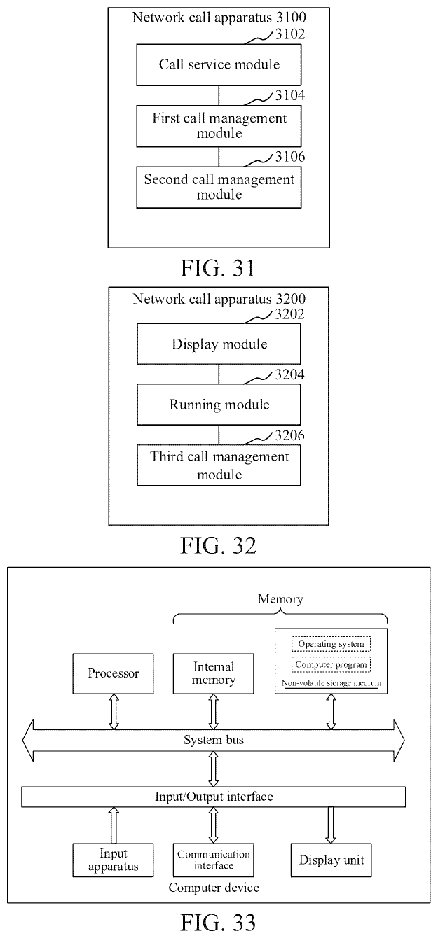

In an embodiment, as shown in FIG. 31, a network call apparatus 3100 is provided. The apparatus specifically includes:
a call service module 3102, configured to create, in response to a call trigger operation triggered by a first communication user in a first instant messaging application, a virtual room configured for a network call, and add the first communication user to the virtual room;
a first call management module 3104, configured to transmit a child application card indicating the virtual room to a second instant messaging application used by a second communication user; the second instant messaging application and the first instant messaging application being different types of applications; and the child application card being configured to indicate the second instant messaging application to enter a child application running in the second instant messaging application, add the second communication user to the virtual room in the child application, and participate in a network call in the virtual room by using a network call engine integrated in the second instant messaging application; and
a second call management module 3106, configured to participate in the network call in the virtual room by using the network call engine integrated in the first instant messaging application.

In an embodiment, the call service module 3102 is further configured to: create, in response to a call trigger operation triggered by the first communication user on an interworking group existing in the first instant messaging application, a virtual room configured for a network call, and add the first communication user to the virtual room; the interworking group including the first communication user and the second communication user.

In an embodiment, the interworking group further includes a third communication user logging in to a third instant messaging application. The third instant messaging application is the same type of application as the first instant messaging application. The apparatus further includes:
a device management module, configured to display, on a group session page of the interworking group when the first communication user is outside the created virtual room, call invitation information transmitted by the third instant messaging application; the call invitation information designating a virtual room which is designated by the third communication user and includes the third communication user; and
the call service module 3102 is further configured to: add, in response to a trigger operation performed by the first communication user on the call invitation information displayed on the group session page, the first communication user to the virtual room designated by the third communication user, and participate in a network call in the virtual room designated by the third communication user.

In an embodiment, the device management module is further configured to display a call invitation prompt in a notification region in a collapsed state of the group session page; the call invitation prompt pointing to the call invitation information transmitted by the third instant messaging application; expand the notification region in the collapsed state into a notification region in an expanded state in response to a trigger operation on the call invitation prompt; and display the call invitation information in the notification region in the expanded state.

In an embodiment, the call invitation information is displayed as a call invitation native card on the group session page of the interworking group; and the call service module 3102 is further configured to add, in response to a trigger operation performed by the first communication user on the call invitation native card displayed on the group session page, the first communication user to the virtual room designated by the third communication user, and participate, by using the network call engine integrated in the first instant messaging application, in a network call in the virtual room designated by the third communication user.

In an embodiment, the device management module is further configured to display at least one outside-group communication user in response to a sharing operation triggered for the virtual room; the outside-group communication user being a communication user outside the interworking group; and the first call management module 3104 is further configured to: transmit, in response to a selection operation on displayed at least one outside-group communication user, join-group call invitation information to the outside-group communication user selected by the selection operation, the join-group call invitation information being configured for indicating the selected outside-group communication user to join the virtual room, and participate in the network call.

In an embodiment, the device management module is further configured to display an outside-group communication user page in response to the sharing operation triggered for the virtual room; and display, on the outside-group communication user page, at least one outside-group communication user having a social relationship with the first communication user.

In an embodiment, the device management module is further configured to: present a default first tab on the outside-group communication user page, and display, in the first tab, at least one outside-group communication user having a social relationship with the first communication user; switch the first tab to a second tab in response to a tab switching operation triggered on the outside-group communication user page; and display, in the second tab, at least one outside-group communication user that does not have the social relationship with the first communication user, and participates in a historical cooperation event with the first communication user.

In an embodiment, the first call management module 3104 is further configured to: transmit, in response to the selection operation on the displayed at least one outside-group communication user, the join-group call invitation information to the outside-group communication user selected by the selection operation when a quantity of communication users in the virtual room is less than or equal to a preset object upper limit; and the device management module is further configured to: display, in response to the selection operation on the displayed at least one outside-group communication user, prompt information configured for representing a failure in selecting a communication user when the quantity of communication users in the virtual room is greater than the preset object upper limit.

In an embodiment, the apparatus further includes:

a device management module, configured to display a call interface of the network call; the call interface including a member region and a control region that are displayed on the same screen; the member region being configured for displaying an identification image of a communication user participating in the network call; and the control region being configured for controlling the network call; and increase an area of the member region and decrease an area of the control region when a quantity of communication users participating in the network call exceeds a quantity of identification images able to be accommodated in the member region; the member region with an increased area being configured for displaying more identification images than the quantity of identification images.

In an embodiment, a quantity of lines formed by arranging control controls in the control region with a decreased area is smaller than a quantity of lines formed by arranging control controls accommodated before the area of the control region is decreased.

In an embodiment, the device management module is further configured to display a page turning control when the quantity of communication users participating in the network call exceeds the quantity of identification images able to be accommodated in the member region with an increased area, and display a page of identification images able to be accommodated in the member region with an increased area; and display a next page of identification images in the member region with an increased area in response to a trigger operation on the page turning control, identification images displayed on different pages belonging to different communication users.

In an embodiment, the apparatus further includes:
a device management module, configured to display a screen sharing control for the network call; and
the first call management module 3104 is further configured to: establish, in response to a trigger operation for the screen sharing control, a screen presentation connection to the network call engine integrated in the second instant messaging application by using the network call engine integrated in the first instant messaging application; and transmit, based on the screen presentation connection, a screen picture collected by the first instant messaging application.

In an embodiment, the apparatus further includes:

a device management module, configured to display, when the second communication user is in a permission limited state and when receiving a permission limitation release request transmitted by the second instant messaging application, a floating bubble that indicates the permission limitation release request; display, in response to a trigger operation for the floating bubble, a request processing page for the permission limitation release request; and display a permission management option for the permission limitation release request on the request processing page; the permission management option being configured for triggering permission processing on the permission limitation release request.

In an embodiment, the virtual room includes a logical room maintained on a first communication platform, and further includes a multimedia room maintained on a second communication platform. The first communication platform is configured to support remote interaction with the first instant messaging application, and the second communication platform is configured to support remote interaction with the second instant messaging application. The logical room is configured to support interaction logic of the virtual room, and the multimedia room is configured to support multimedia interaction of the virtual room.

In the foregoing network call apparatus, a virtual room configured for a network call is created in response to a call trigger operation triggered by the first communication user in the first instant messaging application, the first communication user is added to the virtual room, and a child application card indicating the virtual room is transmitted to the second instant messaging application used by the second communication user. The second instant messaging application and the first instant messaging application are different types of applications. The child application card is configured to indicate the second instant messaging application to enter a child application running in the second instant messaging application, add the second communication user to the virtual room in the child application, and participate in a network call in the virtual room by using a network call engine integrated in the second instant messaging application. The network call is participated in the virtual room by using the network call engine integrated in the first instant messaging application. Compared with a conventional call manner in which all call participants can implement a network call only based on the same instant messaging application, in this application, the same network call engine is integrated into instant messaging applications of different types, based on the same network call engine, and instant communication users logging in by using different instant messaging applications are added to the same virtual room by using a child application, so that instant communication users logging in by using different instant messaging applications can perform a cross-application network call in the virtual room, thereby improving network call efficiency, and in particular, improving network call efficiency for a multi-person network call scenario.

In an embodiment, as shown in FIG. 32, a network call apparatus 3200 is provided. The apparatus specifically includes:
a display module 3202, configured to display, in a second instant messaging application to which a second communication user logs in, a child application card that is triggered by a first communication user by using a first instant messaging application; the child application card designating a virtual room created by using the first instant messaging application; the first communication user being added to the virtual room, and the virtual room being configured for the first communication user to participate in a network call by using a network call engine integrated in the first instant messaging application; and the second instant messaging application and the first instant messaging application being different types of applications;
a running module 3204, configured to: run, in response to a trigger operation performed by the second communication user on the child application card, a child application indicated by the child application card in the second instant messaging application; and
a third call management module 3206, configured to add the second communication user to the virtual room by using the child application, and participate in the network call in the virtual room by using the network call engine integrated in the second instant messaging application.

In an embodiment, the virtual room includes a logical room maintained on a first communication platform, and further includes a multimedia room maintained on a second communication platform. The first communication platform is configured to support remote interaction with the first instant messaging application, and the second communication platform is configured to support remote interaction with the second instant messaging application. The logical room is configured to support interaction logic of the virtual room, and the multimedia room is configured to support multimedia interaction of the virtual room.

In the foregoing network call apparatus, the child application card triggered by the first communication user by using the first instant messaging application is displayed in the second instant messaging application to which the second communication user logs in. The child application card designates a virtual room created by using the first instant messaging application; the first communication user is added to the virtual room, and the virtual room is configured for the first communication user to participate in a network call by using a network call engine integrated in the first instant messaging application; and the second instant messaging application and the first instant messaging application are different types of applications. In response to a trigger operation performed by the second communication user on the child application card, the child application indicated by the child application card is run in the second instant messaging application, and the second communication user is added to the virtual room by using the child application. In the virtual room, the second communication user participates in the network call by using the network call engine integrated in the second instant messaging application. Compared with a conventional call manner in which all call participants can implement a network call only based on the same instant messaging application, in this application, the same network call engine is integrated into instant messaging applications of different types, based on the same network call engine, and instant communication users logging in by using different instant messaging applications are added to the same virtual room by using a child application, so that instant communication users logging in by using different instant messaging applications can perform a cross-application network call in the virtual room, thereby improving network call efficiency, and in particular, improving network call efficiency for a multi-person network call scenario.

All or some of the modules in the foregoing network call apparatus may be implemented by using software, hardware, and a combination thereof. The foregoing modules may be embedded in or independent of a processor in the computer device in a hardware form, or may be stored in a memory in the computer device in a software form, so that the processor invokes the software to execute operations corresponding to the foregoing modules.

In an embodiment, a computer device is provided. The computer device may be a terminal, and an internal structure diagram of the computer device may be shown in FIG. 33. The computer device includes a processor, a memory, an input/output interface, a communication interface, a display unit, and an input apparatus. The processor, the memory, and the input/output interface are connected to each other by using a system bus, and the communication interface, the display unit, and the input apparatus are connected to the system bus by using the input/output interface. The processor of the computer device is configured to provide a computing and control capability. The memory of the computer device includes a non-volatile storage medium and an internal memory. The non-volatile storage medium stores an operating system and a computer program. The internal memory provides an environment for running of the operating system and the computer program in the non-volatile storage medium. The input/output interface of the computer device is configured to exchange information between the processor and an external device. The communication interface of the computer device is configured to communicate with an external terminal in a wired or wireless manner. The wireless manner may be implemented by using Wi-Fi, a mobile cellular network, a near field communication (NFC), or another technology. The computer program is executed by the processor to implement a network call method. The display unit of the computer device is configured to form a visual picture, and may be a display screen, a projection apparatus, or a virtual reality imaging apparatus. The display screen may be a liquid crystal display screen or an electronic ink display screen. The input apparatus of the computer device may be a touch layer covering the display screen, may be a key, a trackball, or a touchpad disposed on a housing of the computer device, or may be an external keyboard, touchpad, or mouse.

A person skilled in the art may understand that the structure shown in FIG. 33 is merely a block diagram of a partial structure related to the solutions of this application, and does not constitute a limitation on the computer device to which the solutions of this application are applied. A specific computer device may include more or fewer components than those shown in the figure, or combine some components, or have different component arrangements.

An embodiment further provides a computer device. The computer device includes a memory and a processor. The memory stores a computer program. The processor implements the operations of each method embodiment when executing the computer program.

An embodiment provides a computer-readable storage medium. The computer-readable storage medium has a computer program stored therein. The computer program implements the operations of each method embodiment when being executed by a processor.

An embodiment provides a computer program product. The computer program product includes a computer program. The computer program implements the operations of each method embodiment when being executed by a processor.

User information (including but not limited to user device information, user personal information, and the like) and data (including but not limited to data configured for analysis, stored data, and displayed data) involved in this application are information and data that are authorized by a user or that are fully authorized by each party, and related data needs to be collected, used, and processed in compliance with relevant national laws and standards.

A person of ordinary skill in the art may understand that all or some of procedures of the method in the foregoing embodiments may be implemented by a computer program instructing relevant hardware. The program may be stored in a non-volatile computer-readable storage medium. When the program is executed, the procedures of the foregoing method embodiments may be implemented. Any reference to a memory, a storage, a database, or other media used in all the embodiments provided by this application may include at least one of a nonvolatile memory and a volatile memory. The non-volatile memory may include a read-only memory (ROM), a magnetic tape, a floppy disk, a flash memory, or an optical storage. The volatile memory may include a random access memory (RAM) or an external cache. As an illustration but not a limitation, the RAM may be in a plurality of forms, such as a static random access memory (SRAM) or a dynamic random access memory (DRAM).

Technical features of the foregoing embodiments may be combined in different manners to form other embodiments. To make description concise, not all possible combinations of the technical features in the foregoing embodiments are described. However, the combinations of these technical features shall be considered as falling within the scope recorded by this specification provided that no conflict exists.

The foregoing embodiments only describe several implementations of this application, which are described specifically and in detail, but cannot be construed as a limitation to the patent scope of this application. For a person of ordinary skill in the art, several transformations and improvements can be made without departing from the idea of this application. These transformations and improvements belong to the protection scope of this application. Therefore, the protection scope of the patent of this application shall be subject to the appended claims.

What is claimed is:

1. A network voice call method performed by a computer device and the method comprising:
in response to a call trigger operation triggered by a first communication user in a first instant messaging application, creating a virtual room configured for a network voice call and adding the first communication user to the virtual room;
transmitting a child application card indicating the virtual room to a second instant messaging application used by a second communication user; the second instant messaging application and the first instant messaging application being different types of applications;
enabling the second communication user to participate in the network voice call in the virtual room by using a network call engine integrated in the second instant messaging application; and
enabling the first communication user to participate in the network voice call in the virtual room by using the network call engine integrated in the first instant messaging application.

2. The method according to claim 1, wherein the creating a virtual room configured for a network voice call and adding the first communication user to the virtual room comprises:
in response to a call trigger operation triggered by the first communication user on an interworking group existing in the first instant messaging application, creating a virtual room configured for a network voice call, and adding the first communication user to the virtual room;
the interworking group comprising the first communication user and the second communication user.

3. The method according to claim 2, wherein the interworking group further comprises a third communication user who logs into a third instant messaging application; the third instant messaging application is a same type of application as the first instant messaging application; and the method further comprises:
displaying, when the first communication user is outside the created virtual room, call invitation information transmitted by the third instant messaging application on a group session page of the interworking group; and
in response to a trigger operation performed by the first communication user on the call invitation information displayed on the group session page, enabling the first communication user to participate in the network call in the virtual room designated by the third communication user.

4. The method according to claim 2, wherein the method further comprises:
displaying at least one outside-group communication user in response to a sharing operation triggered for the virtual room; and
in response to a selection operation on displayed at least one outside-group communication user, transmitting join-group call invitation information to the outside-group communication user selected by the selection operation.

5. The method according to claim 1, wherein the method further comprises:
displaying a call interface of the network voice call, the call interface comprising a member region and a control region that are displayed on a same screen; and
adjusting an area of the member region when a quantity of communication users participating in the network call exceeds a quantity of identification images to be accommodated in the member region.

6. The method according to claim 5, wherein a quantity of lines formed by arranging control controls in the control region with a decreased area is smaller than a quantity of lines formed by arranging control controls accommodated before the area of the control region is decreased.

7. The method according to claim 1, wherein the method further comprises:
displaying a screen sharing control for the network voice call;
in response to a trigger operation for the screen sharing control, establishing a screen presentation connection to the network voice call engine integrated in the second instant messaging application by using the network call engine integrated in the first instant messaging application; and
transmitting, based on the screen presentation connection, a screen picture collected by the first instant messaging application.

8. The method according to claim 1, wherein the method further comprises:
displaying, when the second communication user is in a permission limited state and when receiving a permission limitation release request transmitted by the second instant messaging application, a floating bubble that indicates the permission limitation release request;
displaying, in response to a trigger operation for the floating bubble, a request processing page for the permission limitation release request; and
displaying a permission management option for the permission limitation release request on the request processing page; the permission management option being configured for triggering permission processing on the permission limitation release request.

9. The method according to claim 1, wherein the virtual room comprises a logical room maintained on a first communication platform, and a multimedia room maintained on a second communication platform; the first communication platform is configured to support remote interaction with the first instant messaging application, and the second communication platform is configured to support remote interaction with the second instant messaging application; and the logical room is configured to support interaction logic of the virtual room, and the multimedia room is configured to support multimedia interaction of the virtual room.

10. A computer device, comprising a memory and a processor, the memory storing a computer program therein, and the computer program, when executed by the processor, causing the computer device to implement a network voice call method including:
in response to a call trigger operation triggered by a first communication user in a first instant messaging application, creating a virtual room configured for a network voice call and adding the first communication user to the virtual room;
transmitting a child application card indicating the virtual room to a second instant messaging application used by a second communication user; the second instant messaging application and the first instant messaging application being different types of applications;
enabling the second communication user to participate in the network voice call in the virtual room by using a network call engine integrated in the second instant messaging application; and
enabling the first communication user to participate in the network voice call in the virtual room by using the network call engine integrated in the first instant messaging application.

11. The computer device according to claim 10, wherein the creating a virtual room configured for a network voice call and adding the first communication user to the virtual room comprises:
in response to a call trigger operation triggered by the first communication user on an interworking group existing in the first instant messaging application, creating a virtual room configured for a network voice call, and adding the first communication user to the virtual room;
the interworking group comprising the first communication user and the second communication user.

12. The computer device according to claim 11, wherein the interworking group further comprises a third communication user who logs into a third instant messaging application;
the third instant messaging application is a same type of application as the first instant messaging application; and the method further comprises:
displaying, when the first communication user is outside the created virtual room, call invitation information transmitted by the third instant messaging application on a group session page of the interworking group; and
in response to a trigger operation performed by the first communication user on the call invitation information displayed on the group session page, enabling the first communication user to participate in the network call in the virtual room designated by the third communication user.

13. The computer device according to claim 11, wherein the method further comprises:
displaying at least one outside-group communication user in response to a sharing operation triggered for the virtual room; and
in response to a selection operation on displayed at least one outside-group communication user, transmitting join-group call invitation information to the outside-group communication user selected by the selection operation.

14. The computer device according to claim 10, wherein the method further comprises:
displaying a call interface of the network voice call, the call interface comprising a member region and a control region that are displayed on a same screen; and
adjusting an area of the member region when a quantity of communication users participating in the network call exceeds a quantity of identification images to be accommodated in the member region.

15. The computer device according to claim 14, wherein a quantity of lines formed by arranging control controls in the control region with a decreased area is smaller than a quantity of lines formed by arranging control controls accommodated before the area of the control region is decreased.

16. The computer device according to claim 10, wherein the method further comprises:
displaying a screen sharing control for the network voice call;
in response to a trigger operation for the screen sharing control, establishing a screen presentation connection to the network voice call engine integrated in the second instant messaging application by using the network call engine integrated in the first instant messaging application; and
transmitting, based on the screen presentation connection, a screen picture collected by the first instant messaging application.

17. The computer device according to claim 10, wherein the method further comprises:
displaying, when the second communication user is in a permission limited state and when receiving a permission limitation release request transmitted by the second instant messaging application, a floating bubble that indicates the permission limitation release request;
displaying, in response to a trigger operation for the floating bubble, a request processing page for the permission limitation release request; and
displaying a permission management option for the permission limitation release request on the request processing page; the permission management option being configured for triggering permission processing on the permission limitation release request.

18. The computer device according to claim 10, wherein the virtual room comprises a logical room maintained on a first communication platform, and a multimedia room maintained on a second communication platform; the first communication platform is configured to support remote interaction with the first instant messaging application, and the second communication platform is configured to support remote interaction with the second instant messaging application; and the logical room is configured to support interaction logic of the virtual room, and the multimedia room is configured to support multimedia interaction of the virtual room.

19. A non-transitory computer-readable storage medium having a computer program stored therein, the computer program, when executed by a processor of a computer device, causing the computer device to implement a network voice call method including:
in response to a call trigger operation triggered by a first communication user in a first instant messaging application, creating a virtual room configured for a network voice call and adding the first communication user to the virtual room;
transmitting a child application card indicating the virtual room to a second instant messaging application used by a second communication user; the second instant messaging application and the first instant messaging application being different types of applications;
enabling the second communication user to participate in the network voice call in the virtual room by using a network call engine integrated in the second instant messaging application; and
enabling the first communication user to participate in the network voice call in the virtual room by using the network call engine integrated in the first instant messaging application.

20. The non-transitory computer-readable storage medium according to claim 19, wherein the virtual room comprises a logical room maintained on a first communication platform, and a multimedia room maintained on a second communication platform; the first communication platform is configured to support remote interaction with the first instant messaging application, and the second communication platform is configured to support remote interaction with the second instant messaging application; and the logical room is configured to support interaction logic of the virtual room, and the multimedia room is configured to support multimedia interaction of the virtual room.
